(19) United States
(12) Patent Application Publication
(10) Pub. No.: US 2025/0335278 A1
(43) Pub. Date: Oct. 30, 2025

(54) ERROR PREDICTION IN LOCATION SENSOR DATA USING MACHINE LEARNING MODEL

(71) Applicant: HERE Global B.V., Eindhoven (NL)

(72) Inventors: Amarnath NAYAK, Mumbai (IN); Advait Mohan RAUT, Virar West (IN); Aleksandr AVERBUCH, Buffalo Grove, IL (US)

(21) Appl. No.: 18/649,222

(22) Filed: Apr. 29, 2024

(51) Int. Cl. G06F 11/07

(52) U.S. Cl. CPC G06F 11/0751; G06F 11/0721

(57) ABSTRACT

A method of predicting errors in location sensor data is disclosed. The method may include retrieving, from a map database, lane geometry information associated with a first lane within a first road link in a geographic region and obtaining the first location sensor data for a first set of reference points. The method may further include associating each reference point with a respective portion of the lane geometry information and calculating a first error associated with the obtained first location sensor data based on the respective portion of lane geometry information. The method may further include obtaining a first set of features associated with each of the first set of reference points and training a machine learning (ML) model using the calculated first error and the obtained first set of features.

### BACKGROUND

With advancements in the field of signal processing, various applications such as navigation systems have emerged that assist users in a variety of ways. Generally, global navigation satellite systems (GNSS) refer to technologies and tools that assist users in determining their location and guiding them to a specific destination. Examples of navigation systems may include Global Positioning System (GPS), Globalnaya Navigazionnaya Sputnikovaya Sistema (GLONASS), Galileo, and the like. For example, the GPS is a satellite-based navigation system that enables precise location tracking and time information anywhere on Earth. The GPS may include a constellation of several satellites (for example, 24 or more satellites) orbiting the Earth, ensuring global coverage and continuous operation. These satellites transmit signals that are received by GPS receivers, which calculate their exact position by triangulating signals from multiple satellites.

Nowadays, GNSS has found a wide range of applications in navigation and positioning technology, especially in automobiles. The GNSS-enabled system provides real-time positioning, velocity, and timing information, facilitating efficient route planning, precise vehicle tracking, and accurate time synchronization for automobiles. As such, in the transportation industry, GNSS plays a pivotal role in enhancing the efficiency of logistics and fleet management, leading to optimized routes, reduced fuel consumption, and improved delivery times.

However, GNSS probe data (or location sensor data) along with probe data associated with other navigation systems (such as GPS, GLONASS, Galileo, and the like) generally suffers from spatial error. The spatial error in GNSS data refers to inaccuracies or discrepancies between the recorded GNSS position and the actual true location of a point on the surface of the Earth. This spatial error arises due to various factors, including atmospheric interference, signal blockage or obstruction, multipath interference, and inaccuracies in satellite orbits and clocks. Such spatial errors lead to inaccuracies in positioning data, impacting the precision and reliability of navigation-based applications. As such, addressing spatial errors is crucial for navigation-based applications that require precise positioning, such as in surveying, navigation, and autonomous vehicle operations.

Therefore, there is a need for efficient and effective systems and methods for accurately predicting spatial error in GNSS data.

### SOME EXAMPLE EMBODIMENTS

According to one embodiment, a method of predicting error in location sensor data is disclosed. The method includes retrieving, from a map database, lane geometry information associated with a first lane within a first road link in a geographic region. The method further includes obtaining first location sensor data for a first set of reference points. The first location sensor data may be obtained from at least one vehicle traveling on a road associated with the first lane. The method further includes associating each reference point with a respective portion of the lane geometry information. The method further includes calculating a first error associated with the obtained first location sensor data based on the respective portion of lane geometry information. The method further includes obtaining a first set of features associated with each of the first set of reference points. The obtained first set of features may be associated with at least one of the altitude information associated with the respective reference point, or terrain information associated with the respective reference point, or a combination thereof. The method further includes training a machine learning (ML) model using the calculated first error and the obtained first set of features. The method may be a computer-implemented method.

According to another embodiment, a system for predicting an error in location sensor data is disclosed. The system includes at least one processor and at least one memory including computer program code for one or more programs. The system further includes a machine learning (ML) model trained on a first training dataset associated with at least a first lane within a first road link. The at least one memory and the computer program code are configured to, with the at least one processor, cause the system to retrieve, from a map database, lane geometry information associated with a second lane within a second road link in a geographic region. The system is further caused to obtain second location sensor data for a second set of reference points. The second location sensor data may be obtained from at least one vehicle traveling on a road associated with the second lane. The system is further caused to obtain a second set of features associated with each of the second set of reference points. The obtained second set of features may be associated with at least one of altitude information associated with the respective reference point, or terrain information associated with the respective reference point, or a combination thereof. The system is further caused to provide, as an input, the obtained second set of features to the ML model and predict a second error associated with at least one of the second location sensor data, the second lane, or the obtained second set of features associated with the second lane based on an output of the ML model.

According to yet another embodiment, a non-transitory computer-readable medium having stored thereon, computer-executable instructions that when executed by a processor of a system, cause the processor to predict an error in location sensor data. The operations include retrieving, from a map database, lane geometry information associated with a second lane within a second road link in a geographic region. The operations further include obtaining second location sensor data for a second set of reference points. The second location sensor data may be obtained from at least one vehicle traveling on a road associated with the second lane. The operations further include obtaining a second set of features associated with each of the second set of reference points. The obtained second set of features may be associated with at least one of altitude information associated with the respective reference point, or terrain information associated with the respective reference point, or a combination thereof. The operations further include providing, as an input, the obtained second set of features to an ML model trained on first training dataset associated with at least a first lane within a first road link. The operations further include predicting a second error associated with at least one of the second location sensor data, the second lane, or the obtained second set of features associated with the second lane based on an output of the ML model.

In addition, for various example embodiments described herein, the following is applicable: a computer program product may be provided. For example, a computer program product comprising instructions which, when executed by a computer, cause the computer to perform any one or any combination of methods, operations, or processes disclosed herein.

According to another embodiment, an apparatus comprises means for error prediction in location sensor data using a machine learning model. The apparatus comprises retrieving, from a map database, lane geometry information associated with a second lane within a second road link in a geographic region. The apparatus further comprises obtaining second location sensor data for a second set of reference points. The second location sensor data may be obtained from at least one vehicle traveling on a road associated with the second lane. The apparatus further comprises obtaining a second set of features associated with each of the second set of reference points. The obtained second set of features may be associated with at least one of altitude information associated with the respective reference point, or terrain information associated with the respective reference point, or a combination thereof. The apparatus further comprises providing, as an input, the obtained second set of features to the ML model and predicting a second error associated with at least one of the second location sensor data, the second lane, or the obtained second set of features associated with the second lane based on an output of the ML model.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side, or in any shared way between service provider and mobile device with actions being performed on both sides.

For various example embodiments, the following is applicable: An apparatus comprising means for performing a method of the claims.

Still, other aspects, features, and advantages of the invention are readily apparent from the following detailed description, simply by illustrating a number of particular embodiments and implementations, including the best mode contemplated for conducting the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of predicting errors in location sensor data using a machine learning (ML) model, according to one embodiment;

FIG. 2 is a diagram of components of the system capable of prediction of error in location sensor data using the ML model, according to one embodiment;

FIG. 3 is a diagram depicting errors in location sensor data associated with a first lane, according to one embodiment;

FIG. 4 is a diagram that illustrates exemplary operations for training machine learning model for prediction of error in location sensor data, in accordance with an embodiment of the disclosure;

FIG. 5 is a diagram that illustrates exemplary operations for predicting errors in location sensor data using a machine learning model, in accordance with an embodiment of the disclosure;

FIG. 5A illustrates an example scenario of operation in accordance with an embodiment of the disclosure.

FIGS. 6A, and 6B are diagrams depicting examples of a portion of a digital elevation model (DEM) of a first geographical region and a second geographical region, according to one embodiment;

FIG. 7 illustrates an exemplary diagram for training and inference of the ML model, in accordance with an embodiment of the disclosure;

FIG. 8 is a flowchart of a method for training the ML model for predicting error in location sensor data, according to one embodiment;

FIG. 9 is a flowchart of a method for predicting error in location sensor data using the trained ML model, according to one embodiment;

FIG. 10 is a diagram of the map database, according to one embodiment;

FIG. 11 is a diagram of hardware that can be used to implement an embodiment;

FIG. 12 is a diagram of a chip set that can be used to implement an embodiment; and

FIG. 13 is a diagram of a mobile terminal (e.g., handset, vehicle, or part thereof) that can be used to implement an embodiment.

### DESCRIPTION OF SOME EMBODIMENTS

Examples of a system, method, and computer program for processing user data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

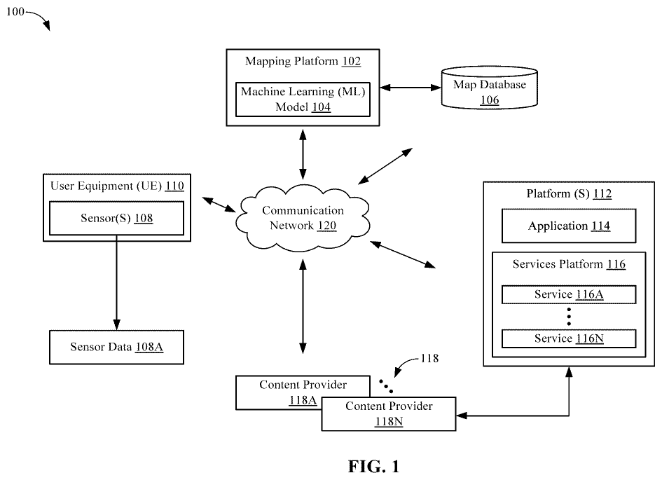

FIG. 1 is a diagram of a system capable of predicting errors in location sensor data using the machine learning (ML) model, according to one embodiment. The system 100 may include a mapping platform 102. The mapping platform 102 may include a machine learning (ML) model 104. The system 100 may further include a map database 106 that includes location sensor data. The system 100 may further include one or more sensors 108 that may capture location sensor data 108A, in particular location sensor data, a user equipment (UE) 110, platform(s) 112, an application 114, a services platform 116, and content providers 118. The services platform 116 may include, for example, a service 116A and a service 116N. The content provider 118 may include, for example, a content provider 118A and a content provider 118N. The system 100 may further include a communication network 120. The content provider 118 or the services platform 116 may provide similar data and/or functionality to a user data database.

Generally, location sensor data refers to information that indicates the geographic position of a particular object or person as captured by e.g. a sensor. The location sensor data typically includes the latitude, longitude, altitude, and timestamp corresponding to the location where the sensors 108 is currently present. Location sensor data, in particular location sensor data, may be stored by a platform, e.g. mapping platform 102, platform(s) 112, or services platform 116. However, sometimes location sensor data suffers from spatial error. The spatial error refers to inaccuracies or discrepancies in the recorded or measured geographic positions of objects or points of interest when compared to their true or intended locations. The spatial errors may occur due to a variety of reasons such as atmospheric interference, signal blockage or obstruction, multipath interference, and inaccuracies in satellite orbits and clocks. Such spatial errors lead to inaccuracies in positioning data, impacting the precision and reliability of various location-based applications (such as navigation applications). Many devices equipped with location sensors may be able to perform a rough device-side estimate of the spatial error based on available satellite count (from the device's perspective) and respective received signal strength for the available satellites, however the rough device-side estimate would not take into account at least some of the other aforementioned spatial error factors. Moreover, many implementations may opt for discarding spatial error information when transmitting larger sensor location datasets, such as trajectories.

The system 100 of the present disclosure enables the prediction of a margin of error in the location sensor data using the ML model 104. The system 100 may be configured to predict a margin of error (e.g. 1 meter, 5 meters, 8 meters, 15 meters, 20 meters, 30 meters, and the like) in the location sensor data associated with a particular road link. The system 100 may utilize the location sensor data 108A captured from one or more sensors 108 and the location sensor data collected by the mapping/location-based services platform to correlate the error.

In an embodiment, the system 100 may further include the map database 106 which includes navigation information of a geographic region, including lane geometry information associated with a first lane within a first road link in the geographic region. In some embodiments, the map database 106 may further include altitude information associated with each reference point of a first set of reference points, or terrain information associated with each reference point of the first set of reference points. In some embodiments, the first set of reference points may correspond to first location sensor data obtained by a location sensor (e.g. a GNSS sensor) of a dedicated vehicle traveling on the first lane within the first road link. In some embodiments, the dedicated vehicle is a vehicle that has verifiably driven on the first lane within the first road. Verification of the vehicle having driven on the first lane may be accomplished, among other methods, by an Operator annotating at least a portion of the first location sensor data to have been driven on at least a portion of the first lane. The Operator may be on-board the vehicle as the vehicle drives on the lane or may annotate the location sensor data a posteriori, e.g. during a review of the driven path using imagery (e.g. from the onboard camera, the camera following the vehicle, or the like.).

In another embodiment, the verification may be done by the dedicated vehicle, which may be equipped with high-precision sensor equipment, such as Differential GPS sensors, Real-Time Kinematic Positioning sensors, LiDAR sensors, Camera sensors, and the like, deriving a precise location of the vehicle. In such an embodiment, the sensor equipment of the dedicated vehicle is superior in accuracy to state-of-the-art consumer-grade, sensor-equipped vehicles, such that the dedicated vehicle can verified as driving on the first lane if the high-precision equipment reports it as such. The first set of reference points may correspond to location sensor data obtained by a consumer-grade GNSS sensor of the dedicated vehicle, collecting location information in parallel to the high-precision sensors. In other words, if the high-precision sensors of the dedicated vehicle indicate that the dedicated vehicle is driving on the first lane, the location sensor data obtained via consumer-grade GNSS sensor(s) may be taken as the first set of reference points.

In some embodiments, a location sensor data point may be associated with a corresponding location along the lane, e.g. with respect to the lane centerline, for example using a map-matching algorithm or process. The map-matching algorithm or process may use the latitude and longitude information of the location sensor data point to find the closest road link on a map database and obtain lane information within said road link. In some embodiments, the lane information comprises lane geometry information, e.g. a lane centerline, for which the map-matching algorithm or process may find a corresponding latitude-longitude pair on the lane geometry corresponding to the location sensor data point. The map-matching algorithm or process may utilize preceding location sensor data points (of the same drive) to the respective location sensor data point to increase the reliability of the match between the location sensor data point and lane geometry location. The map-matching algorithm or process may further associate both location points, for example, in a tuple of, i) a location sensor data point, and ii) a corresponding location on the lane may be used to handle or store such association(s).

In an embodiment, an error associated with the obtained location sensor data based on the respective portion of lane geometry information is calculated. The error may be a discrepancy distance (e.g. Euclidean distance) between the location sensor data point and the location on the lane. In some embodiments, the error may be calculated on the fly, such that storing the distance as part of the tuple may not be required.

To train the ML model 104, the dedicated vehicle may be made to travel along the first road link. In some scenarios, the first road link may include one or more lanes including the first lane, for which the lane geometry information associated with the first lane within the first road link in the geographic region may be already known and may be stored in the map database 106. In other words, during training of the ML model 104, when the dedicated vehicle is traveling along the first lane within the first road link, the lane geometry information associated with the first lane on which the vehicle is traveling may be predetermined.

As mentioned above, the first road link may include one or more lanes including the first lane. Further, the first lane of the first road link may be segmented into a first subset of lane segments, based on at least one distance criterion. For example, each lane segment may be 500, 300, 200, 100, 50, or 10 meters long. The lane segments may be created from the first lane, such that each lane segment may include a reference point from the first set of reference points, such that each reference point may be associated with a respective portion of the lane geometry information.

The system 100 may further include one or more sensors 108 that, in some example embodiments, may be installed in a vehicle traveling on a road associated with the first lane. The one or more sensors 108 may be configured to generate location sensor data 108A. The location sensor data 108A may be associated with the first set of reference points. By way of an example, the one or more sensors 108 may include a Global Satellite Navigation System (GNSS) sensor, such as a GPS sensor, which may be installed in the vehicle and may be configured to generate GNSS data (i.e. location sensor data 108A) through various points of a trip of the vehicle. During training of the ML model 104, as the vehicle moves across the first set of reference points along the first lane, the location sensor data 108A for the first set of reference points may be obtained by the one or more sensors 108.

In an embodiment, the location sensor data 108A may have some spatial error that may refer to a discrepancy between an actual location of a point or object in space and its recorded or estimated location. Such spatial errors are commonplace in positioning technologies, in particular in radio signal-based position technologies (such as GNSS) and affect all sorts of applications requiring location information (cartography, navigation, remote sensing). Such errors may arise due to various factors, including atmospheric interference, signal blockage or obstruction, multipath interference, and inaccuracies in satellite orbits and clocks, and may lead to inaccuracies in positioning data, impacting the precision and reliability of navigation-based applications. Therefore, it may be important to accurately predict the error associated with the location sensor data 108A, to minimize the impact of the spatial errors on the vehicle trajectory and operations.

The system 100 of the present disclosure relies on training the ML model 104 using calculated error data and features associated with the first road link, and then using the trained ML model 104 for predicting errors in the location sensor data associated with a second road link based on features associated with the second road link. To this end, during training of the ML model 104, lane segments (for example, each lane segment being 100 meters in length) may be created for a first lane within the first road link on which the vehicle may be traveling. In an embodiment, the ML model 104 may correspond to a Supervised Learning classifier, such as a random forest-based classifier or an Extreme Gradient Boosting (XGBoost) based classifier. Furthermore, the lane geometry information associated with the first lane may be obtained, for example, from the map database 106. Further, within each lane segment, a reference point may be identified. Furthermore, one or more vehicles may travel on the road associated with the first lane, and location sensor data 108A (i.e. GPS data) for the reference points may be obtained and recorded from the one or more vehicles. Further, each reference point may be associated with a respective portion of the lane geometry information. Thereafter, the error associated with the first lane may be calculated based on the obtained location sensor data 108A. It may be understood that the error may be introduced due to various features including elevation and/or terrain of the road, presence of buildings and traffic along the lane, buildings or hills in the vicinity of the lane, etc. As such, the features associated with each of the reference points may be obtained. The ML model 104 may be trained using the calculated error and the features associated with the first lane within the first road link. Once the ML model 104 is trained (based on the first road link), the ML model 104 may be used for predicting errors in location sensor data associated with the second road link. As such, when the vehicle is traveling on the second lane of the second road link, features (e.g. altitude information, terrain information, etc.) associated with the first set of reference points may be obtained. The features may be provided as input to the trained ML model 104 to predict an error associated with the second lane of the second road link.

In operation, the mapping platform 102 may be configured to retrieve lane geometry information associated with the first lane within the first road link in the geographic region. The lane geometry information may be retrieved from the map database 106. As discussed above, the map database 106 may include navigation information of the geographic region, including lane geometry information associated with the first lane. The mapping platform 102 may be further configured to obtain the first location sensor data for the first set of reference points. The first location sensor data may correspond to location sensor data (or GNSS data) associated with the first set of reference points and may be obtained from at least one vehicle that may be traveling on the road associated with the first lane. The mapping platform 102 may be further configured to associate each reference point with a respective portion of the lane geometry information.

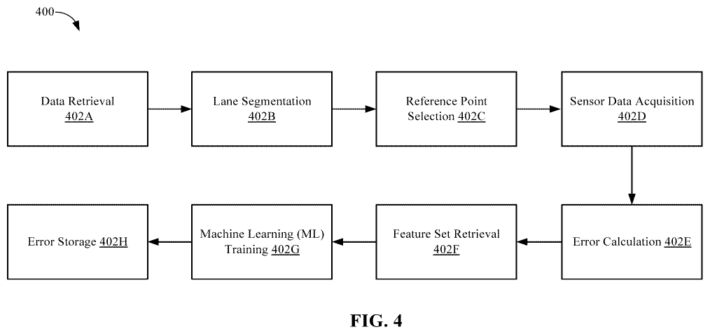

The mapping platform 102 may be further configured to calculate a first error associated with the obtained first location sensor data based on the respective portion of lane geometry information. Based on the calculated first error, a first set of features associated with each of the first set of reference points may be obtained. In an embodiment, the obtained set of features may be associated with at least one of altitude information associated with the respective reference point, or terrain information associated with the respective reference point, or a combination thereof. The altitude information may be associated with the altitude of the respective reference point and the terrain information may be associated with a steepness of the terrain of the respective reference point. Details about the altitude information and the terrain information are provided, for example, in FIG. 4.

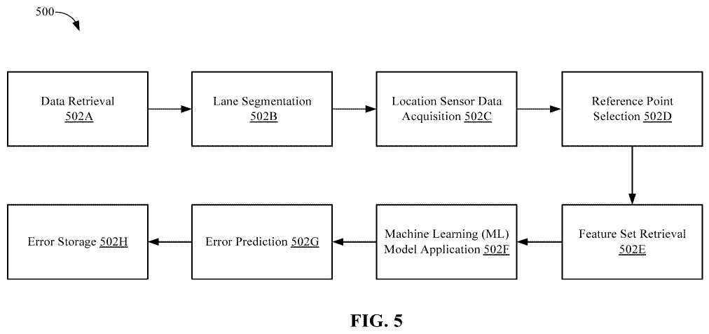

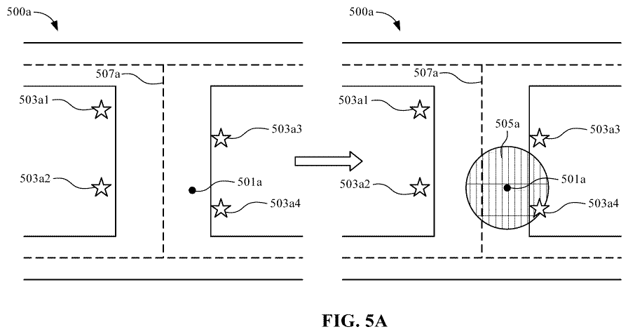

The mapping platform 102 may be further configured to train the ML model 104 using the calculated first error and the obtained first set of features. In an embodiment, the mapping platform 102 may be further configured to update the map database with a value corresponding to the calculated first error associated with the first lane. By way of example and not limitation, the calculated first error associated with the first lane may be 10 meters. Once the ML model 104 is trained, the ML model 104 may be deployed in real-life scenarios to predict the error in a second lane in a second road link different from the first road link. Details about the deployment of the ML model 104 are provided, for example, in FIG. 5.

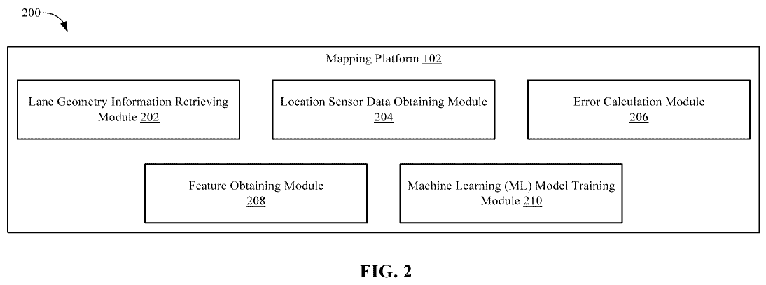

The components of the mapping platform 102 for the prediction of errors in location sensor data using the ML model 104 are described in FIG. 2.

FIG. 2 is a diagram 200 of components of the system 100 capable of prediction of error in location sensor data using the ML model, according to one embodiment. In one embodiment, as shown in FIG. 2, the mapping platform 102 of the system 100 includes one or more components capable of prediction of error in location sensor data using the ML model 104 according to the various embodiments described herein. It is contemplated that the functions of the components of the mapping platform 102 may be combined or performed by other components of equivalent functionality. As shown, in one embodiment, the mapping platform 102 includes a lane geometry information retrieving module 202, a location sensor data obtaining module 204, an error calculation module 206, a feature obtaining module 208, and a machine learning (ML) model training module 210.

The above-presented modules and components of the mapping platform 102 can be implemented in hardware, firmware, software, or a combination thereof. Though depicted as a separate entity in FIG. 1, it is contemplated that the mapping platform 102 may be implemented as a module of any of the components of the system 100 (e.g., a component of the services platform 116, the content providers 118, the UE 110, the application 114, and/or the like). In another embodiment, one or more of the modules 202-210 may be implemented as a cloud-based service, local service, native application, or combination thereof. The functions of the mapping platform 102 and modules 202-210 are discussed with respect to the figures below.

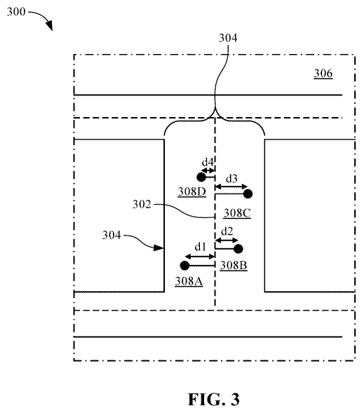

FIG. 3 is a diagram 300 depicting errors in location sensor data associated with a first lane 302, according to one embodiment. The diagram 300 depicts the first lane 302 within a first road link 304 in a geographic region 306. In an embodiment, the mapping platform 102 may be configured to segment the first lane 302 of the first road link 304 into a first subset of lane segments based on at least one distance criterion. For example, the first lane 302 may be of 1000 meters, then the mapping platform 102 may be configured to segment the first lane 302 into 10 lane segments of 100 meters each.

Based on the segmentation, the mapping platform 102 may be configured to select at least one reference point of a first set of reference points 308A-308D from each lane segment of the first subset of lane segments. In an embodiment, the first set of reference points 308A-308D corresponds to the location of the vehicle as reported by the one or more sensors 108. As an example, each of the first set of reference points 308A-308D may correspond to location sensor data points scattered on the first road link 304.

The mapping platform 102 may be configured to retrieve lane geometry information associated with the first lane 302 within the first road link 304 in the geographic region 306. The lane geometry information may be already known and stored in the map database 106 and therefore may be retrieved from the map database 106.

The mapping platform 102 may be configured to retrieve the lane geometry information associated with the first lane 302 within the first road link 304 in the geographic region 306, for example, from the map database 106. As mentioned above, the map database 106 may include navigation information of the geographic region 306, including lane geometry information associated with the first lane 302 within the first road link 304 in the geographic region 306. The mapping platform 102 may be further configured to obtain the first location sensor data for the first set of reference points 308A-308D. The first location sensor data may be obtained from at least one vehicle traveling on the road associated with the first lane 302.

In an embodiment, the location sensor data 108A as reported by the one or more sensors 108 may have an error, with respect to the accurate location of the vehicle in the first lane 302. Due to the error, the first set of reference points 308A-308D as reported by the one or more sensors 108 during the movement of the vehicle on the first lane 302 may be scattered on the first lane 302 away from the accurate location on the first lane 302 on which the vehicle may be traveling. As mentioned above, the accurate location may have been obtained from a verified path driven by a dedicated vehicle. As such, the error may be in proportion to an extent of the deviation of the location reported by the one or more sensors 108 from the accurate location of the first lane 302. In other words, the error may be in proportion to a distance of the location reported by the one or more sensors 108 from the corresponding accurate location. As such, as shown in FIG. 3, the error associated with a first reference point 308A may be in proportion to distance ‘d1’ from the corresponding accurate location, the error associated with a second reference point 308B may be in proportion to distance ‘d2’ from the corresponding accurate location, the error associated with a third reference point 308C may be in proportion to distance ‘d3’ from the corresponding accurate location, and the error associated with a fourth reference point 308D may be in proportion to distance ‘d4’ from the corresponding accurate location. Therefore, the first error associated with the first lane 302 may be calculated based on the obtained location sensor data 108A obtained by the one or more sensors 108.

Additionally, in an embodiment, the first map data associated with the first lane 302 may be retrieved from the map database 106, based on the obtained location sensor data 108A. For example, the first map data associated with the first lane 302 may locate the first lane 302 in the map data for the geographic region 306. Further, the first error may be calculated in the retrieved first map data associated with the first lane 302 based on the obtained location sensor data 108A and the retrieved first map data.

FIG. 4 is a diagram that illustrates exemplary operations for training a machine learning model for the prediction of errors in location sensor data, in accordance with an embodiment of the disclosure. FIG. 4 is explained in conjunction with elements from FIG. 1, FIG. 2, and FIG. 3. With reference to FIG. 4, there is shown a block diagram 400 that illustrates exemplary operations from 402A to 402H, as described herein. The exemplary operations illustrated in the block diagram 400 may start at 402A and may be performed by any computing system, apparatus, or device, such as by the system 100 of FIG. 1. Although illustrated with discrete blocks, the exemplary operations associated with one or more blocks of the block diagram 400 may be divided into additional blocks, combined into fewer blocks, or eliminated, depending on the particular implementation.

At 402A, a data retrieval operation may be performed. In the data retrieval operation, the system 100 may be configured to retrieve lane geometry information associated with a first lane within a first road link in a geographic region. The lane geometry may refer to a design and a layout of lanes on roads, streets, and highways and may provide information about parameters and features that contribute to the safe and efficient movement of traffic on the corresponding road. In some embodiments, the lane geometry information may include information about a width of the first lane, a type of the first lane, a curvature of the first lane, a superelevation of the first lane, and the like.

At 402B, optionally a lane segmentation operation may be performed. In the lane segmentation operation, the system 100 may be configured to segment the first lane. The system 100 may be configured to segment the first lane of the first road link into a first subset of lane segments based on at least one distance criterion. In at least one embodiment, the at least one distance criterion may be associated with a distance parameter. For example, the first lane may be segmented into the first subset of lane segments of a first threshold distance (say 100 meters) each. Such segmentation may allow for providing a discrete or average error value for the segment, rather than a more complex and space-consuming (in e.g. kbytes) error value for each possible location of the road link.

At 402C, a reference point selection operation may be performed. In the reference point selection operation, the system 100 may be configured to select at least one reference point of the first set of reference points from each lane of the first subset of lane segments. In an embodiment, the first set of reference points may correspond to location sensor data points of a verified vehicle trajectory (e.g. of a dedicated vehicle, as discussed above). In another embodiment, the location information of the first set of reference points may be predetermined.

At 402D, a location sensor data acquisition operation may be performed. In the location sensor data acquisition operation, the system 100 may be configured to obtain the first location sensor data for each of the first set of reference points. In an embodiment, the first location sensor data may be obtained from at least one vehicle that may be traveling on a road associated with the first lane. In an embodiment, the one or more sensors 108 may be installed in a vehicle traveling on a road associated with the first lane. The one or more sensors 108 may be configured to generate first location sensor data associated with the first set of reference points. By way of an example, the one or more sensors 108 may include a Global Positioning System (GPS) sensor which may be installed in the vehicle and may be configured to generate GPS data (i.e. location sensor data 108A) through various points of a trip of the vehicle.

In an embodiment, the location sensor data 108A may have some spatial error that may refer to a discrepancy between an actual location of a point or object in space and its recorded or estimated location. Such spatial errors may be often encountered in fields such as geography, cartography, remote sensing, and geographic information systems (GIS). This error may arise due to various factors, including atmospheric interference, signal blockage or obstruction, multipath interference, and inaccuracies in satellite orbits and clocks, and may lead to inaccuracies in positioning data, impacting the precision and reliability of navigation-based applications. Therefore, it may be important to accurately predict the error associated with the location sensor data 108A, to minimize the impact of the spatial errors on the vehicle trajectory and operations.

Examples of the one or more sensors 108, for obtaining location sensor data correspond to the class of Global Navigation Satellite Systems (GNSS)-based sensors. Such one or more sensors 108 may include a Global Positioning System (GPS)-based sensor, a GALILEO-based sensor, a Globalnaya Navigazionnaya Sputnikovaya Sistema (GLONASS)-based sensor, an Indian Regional Navigation Satellite System (IRNSS or NavIC)-based sensor, a BeiDou Navigation Satellite System (BDS)-based sensor, a Quasi-Zenith Satellite System (QZSS)-based sensor, and the like.

Once the location sensor data is obtained, the system 100 may be further configured to associate each reference point with a respective portion of the lane geometry information. Specifically, the system 100 may be configured to associate the lane geometry information associated with the first lane with each reference point within the first lane, since it may be assumed that the verified driving path taken by e.g. the dedicated vehicle corresponds substantially with the center of the lane.

At 402E, an error calculation operation may be performed. In the error calculation operation, the system 100 may be configured to calculate a first error associated with the obtained first location sensor data based on the respective portion of lane geometry information. As will be appreciated, in some scenarios, the location sensor data 108A may not be fully accurate, i.e. there may exist an error associated with the location sensor data 108A. To this end, the mapping platform 102 may be configured to calculate the first error associated with the location sensor data 108A, for example, based on the respective portion of lane geometry information.

It should be noted that the first error associated with the first lane may also depend on the type of sensors (from the one or more sensors 108) that may be used for obtaining the location sensor data 108A. As mentioned above, the one or more sensors 108 may include GNSS sensors such as GPS-based, GLONASS-based, NavIC- or IRNSS-based, GALILEO-based, BDS-based, or QZSS-based sensors. As will be appreciated, the above sensors are associated with different satellite navigation systems, and each of these satellite navigation systems has a different structure of satellite constellations. Due to this reason, the error introduced may be influenced by the type of sensor being used. For better understanding, for example, for the same lane under the same set of conditions, the error associated with the GPS-based sensor may be different from the error associated with the GLONASS-based sensor. Certain example embodiments may therefore train separate ML models to account for the different GNSS constellations.

As discussed, and shown in FIG. 3, the location sensor data 108A as reported by the one or more sensors 108 may have an error, with respect to the accurate location of the vehicle with respect to the first lane 302. Due to the error, the set of reference points 308 as reported by the one or more sensors 108 during the movement of the vehicle on the first lane 302 may be scattered on the first lane 302 away from the accurate location on the first lane 302 on which the vehicle may be traveling. As such, the error may be in proportion to an extent of the deviation of the location reported by the one or more sensors 108 from the accurate location of the first lane 302. In other words, the error may be in proportion to a distance of the location reported by the one or more sensors 108 from the corresponding accurate location.

At 402F, a feature set retrieval operation may be performed. In the feature set retrieval operation, the system 100 may be configured to obtain a first set of features associated with each of the first set of reference points. To obtain the first set of features, the system 100 may be configured to retrieve the first map data associated with the first road link. In an embodiment, the first map data associated with the first road link may be obtained from the map database 106. The first map data may include information associated with the first road link and also include the first set of features.

The first set of features may be associated with at least one of the lane information associated with the first road link, functional class information associated with the first road link, traffic information associated with the first road link, dimension information associated with the first road link, road link environment information associated with the first road link.

The lane information may include information about a number of lanes on the first road link. The functional class information may indicate the functional class of the first road link. The functional class (or the class feature) may be a road type indicator that may reflect a traffic speed and a traffic volume, as well as the importance and connectivity of the road. The functional class of the first road link may be a numerical value ranging from 1 to 5. For example, the functional class “1” may indicate a road with high-volume traffic and maximum-speed traffic. The functional class “2” may indicate a road with a high volume and high-speed traffic. The functional class “3” may indicate a road with a high-volume traffic. The functional class “4” may indicate a road with a high-volume traffic at moderate speeds between neighborhoods and the functional class “5” may indicate a road whose volume and traffic flow may be below the level of any other functional class.

The traffic information associated with the first road link may be indicative of a congestion on the first road link and the dimension information associated with the first road link may be indicative of the width of the first road. The road link environment information associated with the first road link may be indicative of terrain information and altitude information associated with the first road link.

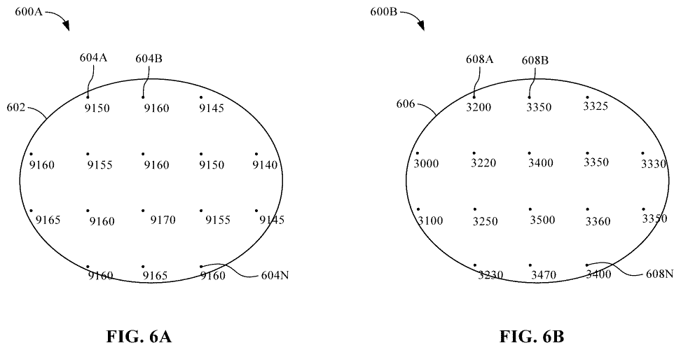

In an embodiment, the first set of features associated with each of the first set of reference points may comprise one of altitude information or altitude information. In embodiments, the system 100 may be configured to calculate a mean altitude value for the first lane based on the altitude information associated with each reference point of the first set of reference points. The system 100 may be further configured to calculate the standard deviation value associated with the steepness of a terrain of the first lane based on the terrain information associated with each reference point of the first set of reference points. Details about the terrain information and altitude information associated with the first road link are provided, for example, in FIGS. 6A and 6B.

In an embodiment, the road link environment information may be information associated with buildings along the first road link and first road link infrastructure. The information associated with a building may include information about one or more structures that may be along the first road link along with their characteristics such as occupied area, height, dimensions, capacity, and the like. The road link infrastructure may include geographic information about the infrastructure of the first road and may include further information about bridges, tunnels, and other drivable structures that may be around or on the first road link.

In case if it is established that the first road link includes bridges, tunnels, and other drivable structures that may be around or on the first road link, the system 100 may be configured to determine a second set of reference points for the first lane segment corresponding to at least one of the bridge, the tunnel, or the parking structure. In an embodiment, the system 100 may be configured to query the map database for at least one of a bridge, a tunnel, or a parking structure. The at least one of the bridge, the tunnel, or the parking structure may be within a predetermined distance of a first-lane segment within the first lane. Based on the query, the system 100 may be configured to determine the second set of reference points for the first lane segment corresponding to at least one of the bridge, the tunnel, or the parking structure. In an embodiment, the second set of reference points may be a second threshold distance (say 20 meters) apart from each other.

The system 100 may be further configured to obtain a second set of features associated with each reference point of the determined second set of reference points. The second set of features may be of similar characteristics to the first set of features but may be associated with the second set of reference points instead of the first set of reference points, since the second set pertains to a different location.

At 402G, a machine learning (ML) training operation may be performed. In the ML training operation, the system 100 may be configured to train the ML model based on the calculated first error and the obtained first set of features and/or the second set of features. Specifically, the system 100 may be configured to generate an association between the calculated first error and the obtained first set of features and/or the second set of features. The machine learning model may be trained to predict an error associated with any road link in the geographical region. Specifically, the trained ML model 104 may be later used for predicting an error associated with a (second) lane or an obtained (second set of) features associated with a second lane within a second road link. The second road link may be in a location different from the location of the first road link over which the ML model 104 is trained. Therefore, the ML model 104 trained with the calculated first error and the obtained first set of features (associated with the first road link) may be used for predicting an error associated with another lane or a set of features associated with the other lane within any other link.

In some embodiments, the ML model 104 may be trained using a calculated mean altitude value and calculated standard deviation value. Details about the calculation of the mean altitude value and standard deviation value are provided, for example, in FIGS. 6A and 6B.

In another embodiment, the error associated with the location sensor data 108A may also depend on the type of sensors (from the one or more sensors 108) used for obtaining the location sensor data 108A. As mentioned above, the one or more sensors 108 may include a GNSS-sensor (e.g. GPS-based, GLONASS-based, NavIC- or IRNSS-based, GALILEO-based, BDS-based, or QZSS-based sensors). As will be appreciated, the above sensors are associated with different satellite navigation systems, and each of these satellite navigation systems has a different structure of satellite constellations. Due to this reason, the error introduced may be influenced by the type of sensor being used. For better understanding, for example, for the same lane under the same set of conditions, the error associated with the GPS-based sensor may be different from the error associated with the GLONASS-based sensor. To this end, the mapping platform 102 may be further configured to train the ML model 104 using the calculated first error and the features associated with the type of sensor (i.e. the satellite navigation system) used for calculating the error. In other words, the set of features for training the ML model 104 may include features associated with the type of sensor or the satellite navigation system used.

Once the ML model 104 is trained, the trained ML model 104 may be deployed. For example, a second lane may be associated with a third set of reference points, in a similar fashion, as explained above. As such, a third set of features associated with each of a third set of reference points may be obtained, such that the obtained third set of features may be associated with the second lane of the first road link. The obtained third set of features may be provided as input to the ML model 104, and a second error associated with the second lane of the first road link may be predicted based on an output of the ML model 104. Details about the deployment of the ML model are provided, for example, in FIG. 5

At 402H, an error storage operation may be performed. In the error storage operation, the mapping platform 102 may be further configured to update the map database 106 with a value corresponding to the calculated first error associated with the first lane. For example, if the calculated first error associated with the first lane is 10 meters, then the corresponding value of the first error (i.e. 10 m) may be associated with the first lane (say as a feature) and stored in the map database for future reference. In some embodiments, the calculated first error may be stored in association with a respective segment of the first lane.

FIG. 5 is a diagram that illustrates exemplary operations for predicting errors in location sensor data using a machine learning model, in accordance with an embodiment of the disclosure. FIG. 5 is explained in conjunction with elements from FIG. 1, FIG. 2, FIG. 3, and FIG. 4. With reference to FIG. 5, there is shown a block diagram 500 that illustrates exemplary operations from 502A to 502H, as described herein. The exemplary operations illustrated in the block diagram 500 may start at 502A and may be performed by any computing system, apparatus, or device, such as by the system 100 of FIG. 1. Although illustrated with discrete blocks, the exemplary operations associated with one or more blocks of the block diagram 500 may be divided into additional blocks, combined into fewer blocks, or eliminated, depending on the particular implementation.

At 502A, a data retrieval operation may be performed. In the data retrieval operation, the system 100 of FIG. 1 may be configured to retrieve lane geometry information of a second lane within a second road link in a geographic region. As discussed above, the retrieved lane geometry information may include information about a width of the second lane, a type of the second lane, a curvature of the second lane, a superelevation of the second lane, and the like.

At 502B, optionally, a lane segmentation operation may be performed. In the lane segmentation operation, the system 100 may be configured to segment the second lane. The system 100 may be configured to segment the second lane of the second road link into a second subset of lane segments based on at least one distance criterion. In at least one embodiment, the at least one distance criterion may be associated with a distance parameter. For example, the second lane may be segmented into the second subset of lane segments of a first threshold distance (say 100 meters) each.

At 502C, a location sensor data acquisition operation may be performed. In the location sensor data acquisition operation, the system 100 may be configured to obtain second location sensor data. In an embodiment, the second location sensor data may be obtained from at least one vehicle that may be traveling on a road associated with the second lane. In an embodiment, the one or more sensors 108 may be installed in a vehicle traveling on a road associated with the second lane. By way of an example, the one or more sensors 108 may include a Global Positioning System (GPS) sensor which may be installed in the vehicle and may be configured to generate GPS data (i.e. location sensor data 108A) through various points of a trip of the vehicle.

At 502D, a reference point selection operation may be performed. In the reference point selection operation, the system 100 may be configured to select at least one reference point of the second set of reference points. The second set of reference points may correspond to each lane of the second subset of lane segments. The selected at least one reference point may be the closest point (in distance) to a location sensor data point obtained at 502C. In other words, the system 100 may find corresponding reference points in the second set of reference points to the respective location sensor data points (108A) obtained by the sensor based on the closest distance. In some embodiments, where the road link has been segmented, the system 100 may query for reference points that correspond to the link segment where the location sensor data points fall.

In an embodiment, the location sensor data 108A may express some spatial error that may refer to a discrepancy between an actual location of a point or object in space and its recorded or estimated location. In such embodiments, the system 100 may expand the search space for reference points to account for reference points that may fall within the margin of error of the corresponding location sensor data 108A. For example, if the location sensor data point identifies a location with a margin of error of e.g. 15 meters, the system 100 may be configured to search for reference points within 15 meters (with an eventual additional buffer of e.g. 2 meters). Details about the location sensor data and the spatial error are provided, for example, in FIG. 4.

At 502E, a feature set retrieval operation may be performed. In the feature set retrieval operation, the system 100 may be configured to obtain a second set of features associated with each of the second set of reference points. To obtain the second set of features, the system 100 may be configured to retrieve the second map data associated with the second road link. In an embodiment, the second map data associated with the second road link may be obtained from the map database 106. The second map may include all the information associated with the second road link and also include the second set of features.

Similar to the first set of features, the second set of features may be associated with at least one of lane information associated with the second road link, functional class information associated with the second road link, traffic information associated with the second road link, dimension information associated with the second road link, road link environment information associated with the second road link. The road link environment may include information associated with buildings along the second road link and second road link infrastructure. Details about the second set of features are provided, for example, in FIG. 4.

In an embodiment, the road link environment information associated with the second road link may be indicative of terrain information and altitude information associated with the second road link. In an embodiment, the system 100 may be configured to calculate a mean altitude value for the second lane based on the altitude information associated with each reference point of the second set of reference points. The system 100 may be further configured to calculate the standard deviation value associated with the steepness of a terrain of the second lane based on the terrain information associated with each reference point of the second set of reference points. Both mean altitude value and standard deviation value may be recorded on the map database 106. Details about the terrain information and altitude information associated with the second road link are provided, for example, in FIGS. 6A and 6B.

In an embodiment, the road link environment information may be information associated with buildings along the second road link and second road link infrastructure. The information associated with a building may include information about one or more structures that may be along the second road link along with their characteristics such as occupied area, height, dimensions, capacity, and the like. The road link infrastructure may include geographic information about the infrastructure of the second road and may include further information about bridges, tunnels, and other drivable structures that may be around or on the second road link.

In an embodiment, the system 100 may be configured to query the map database for at least one of a bridge, a tunnel, or a parking structure. The at least one of the bridge, the tunnel, or the parking structures may be within a predetermined distance of a first lane segment within the second lane. Based on the query, the system 100 may be configured to determine a second set of reference points for the first lane segment corresponding to at least one of the bridge, the tunnel, or the parking structure. In an embodiment, the second set of reference points may be a second threshold distance (say 20 meters) apart from each other.

The system 100 may be further configured to obtain a third set of features associated with each reference point of the determined second set of reference points. The third set of features may be similar to the first set of features but may be associated with the second set of reference points instead of the first set of reference points.

At 502F, a machine learning (ML) model application operation may be performed. In the ML model application operation, the system 100 may be configured to provide the obtained second set of features and/or the obtained third set of features to the ML model 104. The ML model 104 may be a pre-trained model that may be trained on the first training dataset associated with at least a first lane within a first road link. In another embodiment, the system 100 may be configured to provide the calculated mean altitude value and the calculated standard deviation value as an input to the ML model 104. Details about the training of the ML model are provided, for example, in FIG. 4.

At 502G, an error prediction operation may be performed. In the error prediction operation, the system 100 may be configured to predict a second error based on an output of the ML model. In an embodiment, the predicted second error may be associated with at least one of the second location sensor data or the second lane. In another embodiment, the second error may be associated with the obtained second set of features associated with the second lane.

In an embodiment, the system 100 may be configured to compare the predicted second error associated with the second lane with a pre-determined error threshold. The pre-determined error threshold may correspond to a minimum acceptable error value. In case the predicted second error is greater than the pre-determined error threshold, the system 100 may be configured to transmit, based on the comparison, a control command to at least one vehicle traveling on a road associated with the second lane, to control a driving mode of the at least one vehicle. In an embodiment, the controlling the driving mode of the at least one vehicle corresponds to switching from a first driving mode (say from an autonomous or semi-autonomous driving mode) to a second driving mode (say a manual driving mode). This may be done to increase the safety of both the passenger and the vehicle.

At 502H, an error storage operation may be performed. In the error storage operation, the mapping platform 102 may be further configured to update the map database 106 with a value corresponding to the predicted second error associated with the second lane. For example, if the predicted second error associated with the second lane is 20 meters, then the corresponding value of the predicted second error (i.e. 20) may be associated with the second lane (say as a feature) and stored in the map database for future reference. In another embodiment, the value of the predicted second error (i.e. 20) may be associated with at least one of the second location sensor data, or the obtained second set of features associated with the second lane.

FIG. 5A illustrates an example scenario of operation in accordance with an embodiment of the disclosure. The example scenario 500a depicts a portion of an area through which a road link with a road centerline 507a passes. Along the road link are locations 503a1, 503a2, 503a3 and 503a4, which correspond to POIs and/or other objects stored in a map database, e.g. map database 106. Locations 503a1-4 respectively correspond to a café, a hotel, an electric vehicle charge station point, and a restaurant. A location sensor data point 501a reported by a vehicle (e.g. UE 110) places the location of the vehicle proximate to all locations 503a1-4. The location sensor data point is, in this case, provided to a platform or service (e.g. mapping platform 102 or any other platform 112) without an error estimate, such as an initial device-side error estimation. In such a case, it is not possible for the platform or service to reliably determine the correct closest location 503a1-4 to the location sensor data point 501a, since the spatial error of the location sensor data point 501a is not known. However, by applying the aforementioned operations in accordance with FIG. 5, an estimated spatial error can be generated platform/service-side and applied. In the example scenario of FIG. 5A, the spatial error 505a allows for determining that the most likely location for location sensor data point 501a corresponds to location 503a4—the restaurant.

FIGS. 6A, and 6B are diagrams 600A, and 600B respectively, depicting exemplary a portion of a digital elevation model (DEM) of a first geographical region and a second geographical region, according to one embodiment. With reference to FIG. 6A, there is shown a first DEM 602 that may include a first set of points 604. The first DEM 602 may be associated with a first lane and the first set of points 604 may include a first point 602A, a second point 602B, up to the Nth point 602N. Similarly in FIG. 6B, there is shown a second DEM 606 that may include a second set of points 608. The second DEM 606 may be associated with a second lane and the second set of points 608 may include a first point 608A, a second point 608B, up to the Nth point 608N.

The Digital Elevation Model (DEM) may be a representation of the topography or relief of the geographical region of the Earth's surface in a digital format. It provides a three-dimensional representation of the terrain, showing the elevation of the ground at each specific location. The DEM may include the altitude information and terrain information associated with the geographical region and may be widely used in various fields, including geography, geology, hydrology, environmental modeling, and cartography. In an embodiment, the first DEM 602 may be the representation of the topography or relief of a first geographical region and the second DEM 606 may be the representation of the topography or relief of a second geographical region. In general, the DEMs may be obtained from one or more publicly available DEM data sources. For example, some of the publicly available DEM data sources include the Shuttle Radar Topography Mission (SRTM), Advanced Spaceborne Thermal Emission and Reflection Radiometer (Aster), Japan Aerospace Exploration Agency (JAXA) Global Advanced Land Observation Satellite (ALOS), etc.

In an embodiment, with each of the first set of points 604 and the second set of points 608, there is shown an altitude of the corresponding point from the sea level in any unit (say meters). For example, the first point 604A may have an altitude of 9150 meters, the second point 604B may have an altitude of 9160 meters, and the Nth point 604N may have an altitude of 9160 meters. Similarly, the first point 608A may have an altitude of 3200 meters, the second point 608B may have an altitude of 3350 meters, and the Nth point 608N may have an altitude of 3400 feet/1036 meters.

The mapping platform 102 may be configured to calculate a mean altitude value for the first geographic region using the first set of points 604. In an embodiment, the mean altitude value may be calculated by adding up the altitudes of each point of the first set of points 604 and then dividing by a count of the first set of number of points 604. As an example, a first mean altitude value (M1) for the first geographic region may be 9,156 feet/2791 meters, and a second mean altitude value (M2) for the second geographic region may be 3302 feet/1006 meters.

In an embodiment, the mapping platform 102 may be configured to calculate a standard deviation value associated with the steepness of the terrain of the first lane and/or the second lane. In an embodiment, the mapping platform 102 may be configured to calculate a standard deviation value associated with the steepness of the terrain based on the altitude of each point of the first set of points 604. The standard deviation may be a measure of the amount of variation or dispersion in altitude of each point of the first set of points 604 and may quantify an amount of spread or dispersion in a distribution. The standard deviation may be calculated as the square root of the variance which may be a measure of how much the altitude of each point in the first set of points 604 differs from the calculated mean (average) value. As an example, the first standard deviation (σ1) for the first lane may be σ1=8.4 and the first standard deviation (σ2) for the first lane may be σ2=130.4.

As such, the comparative analysis indicates that although the mean elevation for the first geographic area of FIG. 6A is higher than the mean elevation for the second geographic area of FIG. 6B (i.e. M1>M2); however, the steepness of the second geographic area of FIG. 6B is greater than the steepness of the first geographic area of FIG. 6A (i.e. σ2>σ1).

It may be noted that each of the first DEM and the second DEM represents altitude information of respective lanes in the geographic region The altitude information represented by each of the first DEM 602 and the second DEM 606 may include three-dimensional (3D) points located in a plurality of grid points of a grid of the respective DEM. For example, a cell edge for each of the first DEM 602 and the second DEM 606 may be 30 meters. In other words, each grid point of the DEM may indicate the elevation or altitude of the respected grid (i.e. above the sea-level) of a corresponding geographic point. The mean altitude value and the standard deviation value for the geographical area may be calculated using the elevations indicated by the grid points of the respective DEMs. The mean altitude value represents the height above sea-level for the geographical area in general. Further, the standard deviation is suggestive of the terrain steepness for the geographical area. In other words, the mean altitude value may indicate an average height above sea-level for the geographical area, whereas the standard deviation may indicate a variation in elevation, i.e. the steepness of the geographical area.

Further, to estimate the level of steepness of the terrain, an interquartile range (IQR) may be used. As will be understood, the interquartile range (IQR) may be based on the middle 50% of elevation values when ordered from lowest to highest. A comparison of an elevation value for a particular geographic point with the interquartile range (IQR) may indicate a relative steepness level for that geographic point. As can be understood from the exemplary DEMs, a categorization of the steepness of the terrain may be generally subjective. To obtain an objective measure, a random sample of various terrains may be assessed, based on which the mean altitude value and the standard deviation value may be calculated, to thereby create a steepness distribution. Accordingly, based on the number of steepness categories used, buckets of steepness data may be created that may be used for the training of the ML model 104.

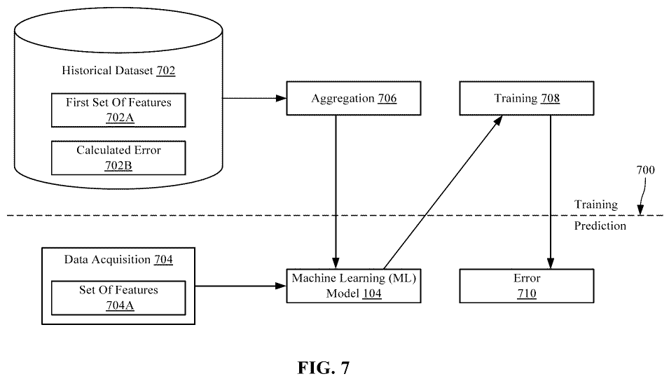

FIG. 7 illustrates an exemplary diagram for training and inference of the ML model 104, in accordance with an embodiment of the disclosure. FIG. 7 is explained in conjunction with elements from FIG. 1, FIG. 2, FIG. 3, FIG. 4, FIG. 5, FIG. 6A, and FIG. 6B. As shown in FIG. 7, there is a training portion above line 700 and an error prediction portion below line 700. With reference to FIG. 7, there is shown a historical dataset 702 that may include the first training dataset.

The historical dataset 702 may include a set of training samples associated with at least one historical event. Each training sample of the set of training samples includes the set of features 702A (e.g. the first set of features), and the calculated error 702B (e.g. the first error) in the location sensor data.

The historical dataset 702 may be aggregated at 706 to predict an error 710 in the location sensor data associated with a lane (say a second lane). Further, after aggregation 706, the data acquisition 704, the set of features 702A, and the calculated error 702B, from aggregation 706, may be used as inputs to the ML model 104. The ML model 104 may further predict the error 710 based on the data acquisition 704, the set of features 702A, and the calculated error 702B. In some embodiments, the trained machine learning model may correspond to at least one of a multivariate time series model and a vector autoregression model.

Further, in the implementation phase, data acquisition 704 is performed. In some embodiments, the data acquisition 704 may include obtaining the set of features 704A, for example, the second set of features. Further, in an embodiment of the present disclosure, the trained ML model 104 may be used to predict error 710 based on the set of features obtained during the data acquisition 704.

In some embodiments, the system 100 may perform data acquisition 704, at periodic intervals, to update a training dataset. Further, the system 100 may re-train the ML model 104 based on the updated training dataset. Further, the ML model 104 may be re-trained using one or more re-training techniques. The one or more re-training techniques may include but are not limited to, batch re-training techniques, active learning re-training techniques, incremental learning re-training techniques, transfer learning re-training techniques, reinforcement learning policies re-training techniques, ensemble method re-training techniques, data augmentation re- training techniques, adaptive learning rates re-training techniques, and the like.

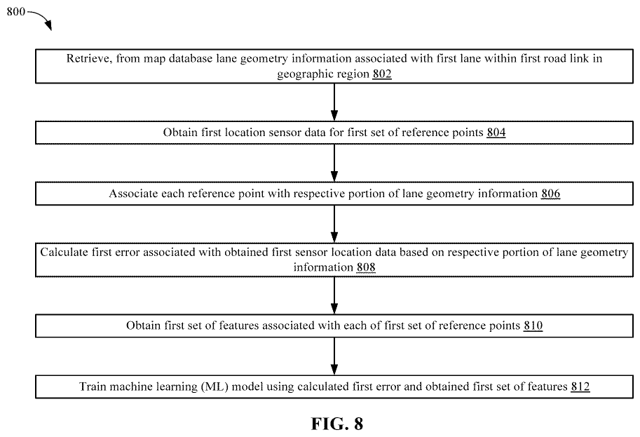

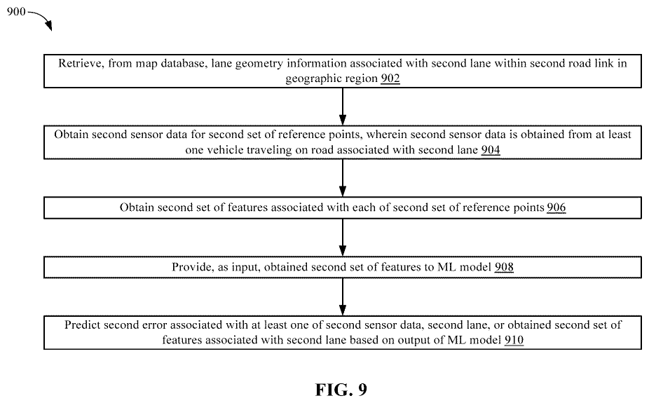

FIG. 8 is a flowchart of a method 800 for training the ML model 104 for predicting errors in location sensor data, according to one embodiment. In various embodiments, the mapping platform 102 and/or any of the modules 202-210 may perform one or more portions of the method 800 and may be implemented in, for instance, a chip set including a processor and a memory as shown in FIG. 8 and FIG. 9. As such, the mapping platform 102 and/or any of the modules 202-210 may provide means for accomplishing various parts of the method 800, as well as means for accomplishing embodiments of other processes described herein in conjunction with other components of the system 100. Although the method 800 is illustrated and described as a sequence of steps, it is contemplated that various embodiments of the method 800 may be performed in any order or combination and need not include all of the illustrated steps.

At step 802, lane geometry information associated with the first lane within the first road link in the geographic region may be retrieved from the map database 106. In some embodiments, the lane geometry information retrieving module 202 may be configured to retrieve the lane geometry information associated with the first lane within the first road link in the geographic region from the map database 106. The map database 106 may include navigation information of a geographic region, along with information associated with a first set of features associated with each of the first set of reference points.

The first set of features may be associated with at least one of altitude information associated with each reference point of the first set of reference points, terrain information associated with each reference point of the first set of reference points, and additionally, with lane information associated with the first road link, functional class information associated with the first road link, traffic information associated with the first road link, dimension information associated with the first road link, and road link environment information associated with the second road link. The road link environment information may include information associated with buildings along the first road link and first road link infrastructure. In an implementation, the first road link may include one or more lanes including a first lane. It should be noted that during training of the ML model 104, when the dedicated vehicle is traveling along the first lane within the first road link, the lane geometry information about the first lane on which the vehicle is traveling is correctly known/verified.

At step 804, the first location sensor data for the first set of reference points may be obtained. The first location sensor data may be obtained from at least one vehicle traveling on a road associated with the first lane. In some embodiments, the location sensor data obtaining module 204 may be configured to obtain the first location sensor data for the first set of reference points associated with the first lane based on the retrieved lane geometry information. The system 100 may include one or more sensors 108 that, in some example embodiments, may be installed in the vehicle traveling on the road associated with the first lane. For example, the one or more sensors 108 may include a Global Positioning System (GPS) sensor which may be installed in the vehicle and may be configured to generate GPS data (i.e. location sensor data 108A) through various points of a trip of the vehicle. During training of the ML model 104, as the vehicle moves across the first set of reference points along the first lane, the location sensor data 108A for the first set of reference points associated with the first lane may be obtained by the one or more sensors 108.

At step 806, each reference point may be associated with a respective portion of the lane geometry information. In an embodiment, the system 100 may be configured to associate each reference point with a respective portion of lane geometry information.

At step 808, a first error associated with the obtained location sensor data 108A may be calculated based on the respective portion of lane geometry information. In some embodiments, the error calculation module 206 may be configured to calculate the first error associated with the obtained location sensor data 108A. In some scenarios, the location sensor data 108A (obtained at step 804) may not be fully accurate, i.e. there may exist an error associated with the location sensor data 108A. To this end, the error calculation module 206 may be configured to calculate the first error associated with the obtained location sensor data 108A, for example, by comparing the lane geometry information associated with the first lane within the first road link and the location sensor data 108A for the first set of reference points. Details of the calculation of the first error are further provided, for example, in FIG. 4.

At step 810, the first set of features associated with each of the first set of reference points may be obtained. In some embodiments, the feature obtaining module 208 may be configured to obtain the first set of features associated with each of the first set of reference points. The obtained first set of features may be associated with at least one of altitude information associated with each reference point of the first set of reference points, or terrain information associated with each reference point of the first set of reference points. Additionally, the first set of features may be further associated with at least one of the lane information associated with the first road link, functional class information associated with the first road link, traffic information associated with the first road link, dimension information associated with the first road link, and road link environment information associated with the first road link. The road link environment information may include information associated with buildings along the first road link and first road link infrastructure.

In some embodiments, to obtain the first set of features associated with each of the first set of reference points, the feature obtaining module 208 may be configured to segment the first lane of the first road link into a first subset of lane segments based on at least one distance criterion. In some embodiments, the at least one distance criterion may include a segmenting distance value which, in an example implementation, may be selected as 100 meters.

In some embodiments, once the first set of features associated with each of the first set of reference points is obtained, the feature obtaining module 208 may be further configured to determine the second set of reference points for the first lane segment based on at least one of the bridge, the tunnel, or the parking space on the first lane. To this end, the feature obtaining module 208 may be configured to query the map database 106 for at least one of a bridge, a tunnel, or a parking structure. The at least one of the bridge, the tunnel, or the parking structures is within a predetermined distance of a first lane segment within the first lane. The feature obtaining module 208 may be further configured to determine the second set of reference points for the first lane segment corresponding to at least one of the bridge, the tunnel, or the parking structure. The obtained second set of features associated with each reference point of the determined second set of reference points may be used to further train the ML model 104.

For example, in some embodiments, the first lane may be segmented into lane segments, such that each lane segment is 20 meters long. Further, the bridge, the tunnel, or the parking space for each of the lane segments may be identified and their height and width may be recorded. Furthermore, based on the height and width associated with the bridge, the tunnel, or the parking space, the second set of features associated with each reference point of the determined second set of reference points may be calculated and used to further train the ML model 104.

At step 812, the ML model 104 may be trained using the calculated first error and the obtained first set of features. In some embodiments, the ML model training module 210 may be configured to train the ML model 104 using the calculated first error and the obtained first set of features. As such, the ML model 104 may be trained on the data associated with the first road link. The trained ML model 104, during the execution phase, may be used for predicting an error associated with a (second) lane or an obtained (second set of) features associated with a second lane within a second road link. The second road link may be different from the first road link over which the ML model 104 is trained. Therefore, the ML model 104 trained with the calculated first error and the obtained first set of features (associated with the first road link) may be used for predicting an error associated with another lane or a set of features associated with the other lane within any other link. Details of the execution phase of the ML model 104 are further provided, for example, in FIG. 6.

In some embodiments, the ML model 104 may be further trained using the calculated mean altitude value and calculated standard deviation value. To this end, the ML model training module 210 may be further configured to calculate a mean altitude value for the first lane based on the altitude information associated with each reference point of the first set of reference points. The mapping platform 102 may be further configured to calculate a standard deviation value associated with the steepness of the terrain of the first lane based on the terrain information associated with each reference point of the first set of reference points. Once the calculated mean altitude value and the calculated standard deviation value have been obtained, the mapping platform 102 may be further configured to train the ML model 104 using the calculated mean altitude value and the calculated standard deviation value. Details of training the ML model 104 using calculated mean altitude value and calculated standard deviation value are further provided, for example, in FIGS. 6A and 6B.

FIG. 9 is a flowchart of a method 900 for predicting error in location sensor data, using the trained ML model 104, according to one embodiment. In various embodiments, the mapping platform 102 and/or any of the modules 202-210 may perform one or more portions of the method 900 and may be implemented in, for instance, a chip set including a processor and a memory as shown in FIG. 8 and FIG. 9. As such, the mapping platform 102 and/or any of the modules 202-210 may provide means for accomplishing various parts of the method 900, as well as means for accomplishing embodiments of other processes described herein in conjunction with other components of the system 100. Although the method 900 is illustrated and described as a sequence of steps, it is contemplated that various embodiments of the method 900 may be performed in any order or combination and need not include all of the illustrated steps.

Once the ML model 104 is trained, for example, on the first road link, i.e. using the calculated first error and the obtained first set of features, the trained ML model 104 may be used to predict an error in the location sensor data associated with a new (i.e. second) lane within a new link (i.e. the second road link).

At step 902, lane geometry information associated with a second lane within a second road link in a geographic region may be retrieved from the map database 106. In an embodiment, the system 100 may be configured to retrieve the lane geometry information associated with the second lane within the second road link in the geographic region. Details about the lane geometry information are provided, for example, in FIGS. 4 and 5.

At step 904, second location sensor data for a second set of reference points may be obtained. The second location sensor data may be obtained from at least one vehicle traveling on a road associated with the second lane. In an embodiment, the system 100 may be configured to obtain the location sensor data. Details about the location sensor data are provided, for example, in FIGS. 4 and 5.

At step 906, the second set of features associated with each of the second set of reference points second road link may be obtained. In some embodiments, the feature obtaining module 208 may be configured to obtain the second set of features associated with each of the second set of reference points. In an embodiment, the system 100 may be configured to obtain the second set of features. Details about the second set of features are provided, for example, in FIGS. 4 and 5.

At step 908, the obtained second set of features may be provided, as an input, to the ML model (for example, the ML model 104 which has been trained through method 800). In some embodiments, the ML model training module 210 may be configured to provide, as input, the obtained second set of features may be input to the ML model 104.

At step 910, a second error associated with at least one of the second location sensor data, the second lane, or the obtained second set of features associated with the second lane may be predicted based on an output of the ML model 104. The obtained second set of features may be provided as the input to the ML model 104 and may predict the second error associated with at least one of the second location sensor data, the second lane, or the obtained second set of features associated with the second lane.

Returning to FIG. 1, as shown, the system 100 includes the services platform 116 for generation of the location sensor data 108A. The services platform 116 may include one or more services, such as a service 116A and a service 116N. The content providers 118 may further include one or more content providers, such as a content provider 118A and a content provider 118N.

The mapping platform 102 may include suitable logic, circuitry, interfaces, and/or code that may be configured to train the ML model 104 and further predict the error in the location sensor data associated with a lane using the trained ML model 104. Examples of the mapping platform 102 may include, but are not limited to, a computing device, a mainframe machine, a server, a computer workstation, a smartphone, a cellular phone, a mobile phone, a gaming device, a consumer electronic (CE) device and/or any other device with data processing capabilities.

The ML model 104 may be a computational network or a system of artificial neurons, arranged in a plurality of layers, as nodes. The plurality of layers of the ML model 104 may include an input layer, one or more hidden layers, and an output layer. Each layer of the plurality of layers may include one or more nodes (or artificial neurons). Outputs of all nodes in the input layer may be coupled to at least one node of the hidden layer(s). Similarly, inputs of each hidden layer may be coupled to outputs of at least one node in other layers of the ML model 104. Outputs of each hidden layer may be coupled to inputs of at least one node in other layers of the ML model 104. Node(s) in the final layer may receive inputs from at least one hidden layer to output a result. The number of layers and the number of nodes in each layer may be determined from the hyper-parameters of the ML model 104. Such hyper-parameters may be set before or while training the ML model 104 on a training dataset.

Each node of the ML model 104 may correspond to a mathematical function (e.g., a sigmoid function or a rectified linear unit) with a set of parameters, tunable during the training of the network. The set of parameters may include, for example, a weight parameter, a regularization parameter, and the like. Each node may use the mathematical function to compute an output based on one or more inputs from nodes in other layer(s) (e.g., previous layer(s)) of the ML model 104. All or some of the nodes of the ML model 104 may correspond to the same or a different mathematical function.

In training of the ML model 104, one or more parameters of each node of the ML model 104 may be updated based on whether an output of the final layer for a given input (from the training dataset) matches a correct result based on a loss function for the ML model 104. The above process may be repeated for the same or a different input until a minimum of loss function may be achieved and a training error may be minimized. Several methods for training are known in the art, for example, gradient descent, stochastic gradient descent, batch gradient descent, gradient boost, meta-heuristics, and the like.

The ML model 104 may include electronic data, such as, for example, a software program, code of the software program, libraries, applications, scripts, or other logic or instructions for execution by a processing device, such as circuitry. The ML model 104 may include code and routines configured to enable a computing device, such as the mapping platform 102 to perform one or more operations. Additionally or alternatively, the ML model 104 may be implemented using hardware including a processor, a microprocessor (e.g., to perform or control the performance of one or more operations), a field-programmable gate array (FPGA), or an application-specific integrated circuit (ASIC). Alternatively, in some embodiments, the ML model 104 may be implemented using a combination of hardware and software. Although in FIG. 1, the ML model 104 is shown integrated within the mapping platform 102, the disclosure is not so limited. Accordingly, in some embodiments, the ML model 104 may be a separate entity in the mapping platform 102, without deviation from the scope of the disclosure. Examples of the ML model 104 may include, a Supervised Learning classifier, such as a random forest based classifier, an Extreme gradient Boosting (XGBoost) based classifier. Other examples of usable ML models 104 may include, but are not limited to, a deep neural network (DNN), a convolutional neural network (CNN), a CNN-recurrent neural network (CNN-RNN), R-CNN, Fast R-CNN, Faster R-CNN, an artificial neural network (ANN), (You Only Look Once) YOLO network, a fully connected neural network, and/or a combination of such networks.

In one embodiment, the mapping platform 102 has connectivity over the communication network 120 to the services platform 116 and provides the one or more services, such as the service 116A and the service 116N that can use the obtained location sensor data 108A for downstream functions. By way of example, the service 116A and the service 116N may be third-party services and include but are not limited to mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the service 116A and the service 116N use the output of the mapping platform 102 (e.g., the location sensor data 108A and lane geometry information associated with the first lane within the first road link in the geographic region stored in the map database 106, etc.) to provide services such as navigation, mapping, other location-based services, etc. to the UE 110, the application 114, and/or other client devices. In one embodiment, the service platform 116 may act as a content provider, analogously to content provider 118A, providing the location sensor data 108A to the mapping platform 102, either directly or via the one or more sensors 108. In some embodiments, the one or more sensors 108 may also be one of the content providers 118 or the services platform 116.

In one embodiment, the mapping platform 102 may be a platform with multiple interconnected components. The mapping platform 102 may include multiple servers, intelligent networking devices, computing devices, components, and corresponding software for the generation of the location sensor data 108A according to the various embodiments described herein. In addition, it is noted that the mapping platform 102 may be a separate entity of the system 100, a part of the service 116A, and the service 116N, a part of the services platform 116, or included within components of the UE 110.

In one embodiment, the content providers 118 may provide content or data (e.g., the location sensor data 108A, related geographic data, etc.) to the map database 106, the mapping platform 102, the services platform 116, the service 116A and the service 116N, the UE 110, and/or the application 114 executing on the UE 110. The content provided may be any type of content, such as location sensor data 108A, machine learning models, permutation matrices, map embeddings, map content, textual content, video content, image content, etc., for example, obtained via the satellite or an aerial vehicle. In one embodiment, the content providers 118 may provide content that may aid in the generation of the (first and/or second) set of features according to the various embodiments described herein. In one embodiment, the content providers 118 may also store content associated with the map database 106, the mapping platform 102, the services platform 116, the service 116A, the service 116N, and/or any other component of the system 100. In another embodiment, the content providers 118 may manage access to a central repository of data, and offer a consistent, standard interface to data, such as a repository of the map database 106.

In one embodiment, the UE 110 may execute software applications (such as the application 114) to use the set of features or other data derived therefrom according to the embodiments described herein. By way of example, the application 114 may also be any type of application that is executable on the UE 110, such as autonomous driving applications, routing applications, mapping applications, location-based service applications, navigation applications, device control applications, content provisioning services, camera/imaging application, media player applications, social networking applications, calendar applications, and the like. In one embodiment, the application 114 may function as a client for the mapping platform 102 and perform one or more functions associated with the generation of the set of features alone or in combination with the mapping platform 102.

By way of example, the UE 110 is or can include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 110 can support any type of interface to the user (such as “wearable” circuitry, etc.). In one embodiment, the UE 110 may be associated with or be a component of a vehicle or any other device.

In one embodiment, the UE 110 is configured with various sensors for the generation of the location sensor data 108A, related geographic data, etc. In one embodiment, the location sensor data 108A represents data associated with a geographic location or coordinates at which location sensor data 108A was collected, and the polyline or polygonal representations of detected objects of interest derived therefrom to generate the digital map data of the map database 106. By way of example, the sensors may include a global positioning sensor for gathering location sensor data (e.g., GPS, GALILEO, BEIDOU, GLONASS, NavIC (IRNSS), IMUs, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors of the UE 110 may include light sensors, orientation sensors augmented with height sensors and acceleration sensors, tilt sensors to detect the degree of incline or decline (e.g., slope) along a path of travel, moisture sensors, pressure sensors, etc. In a further example embodiment, sensors about the perimeter of the UE 110 may detect the relative distance of the device or vehicle from a lane or roadway, the presence of other vehicles, pedestrians, traffic lights, potholes, and any other objects, or a combination thereof. In one scenario, the sensors may detect weather data, traffic information, or a combination thereof. In one embodiment, the UE 110 may include GPS or other satellite-based receivers to obtain geographic coordinates from positioning satellites for determining current location and time. Further, the location can be determined by visual odometry, triangulation systems such as A-GPS, Cell of Origin, or other location extrapolation technologies.

In one embodiment, the communication network 120 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 102, the services platform 116, the service 116A and the service 116N, the UE 110, and/or the content providers 118 communicate with each other and other components of the system 100 using well-known, new, or still developing protocols. In this context, a protocol includes a set of rules defining how the network nodes within the communication network 120 interact with each other based on information sent over the communication links. The protocols are effective at different layers of operation within each node, from generating and receiving physical signals of various types to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a datalink (layer 2) header, an internetwork (layer 3) header and a transport (layer 4) header, and various application (layer 5, layer 6 and layer 7) headers as defined by the OSI Reference Model.

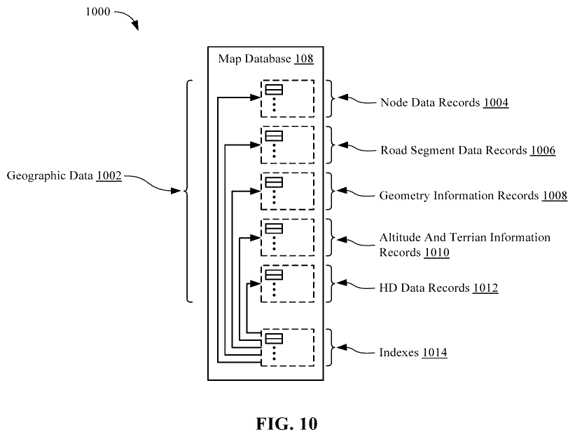

FIG. 10 is a diagram of the map database 106, according to one embodiment. In one embodiment, the map database 106 includes map data 1002 used for (or configured to be compiled to be used for) mapping and/or navigation-related services, such as for providing map embedding analytics according to the embodiments described herein. For example, the map data records stored herein can be used to determine the semantic relationships among the map features, attributes, categories, etc. represented in the map data 1002. In one embodiment, the map database 106 includes high definition (HD) mapping data that provide centimeter-level or better accuracy of map features. For example, map database 106 can be based on Light Detection and Ranging (LiDAR) or equivalent technology to collect billions of 3D points and model road surfaces and other map features down to the number of lanes and their widths. In one embodiment, the HD mapping data (e.g., HD mapping data records 1012) and/or other mapping data of the map database 106 capture and store details such as but not limited to road attributes and/or other features related to generating speed profile data. These details include but are not limited to road width, number of lanes, turn maneuver representations/guides, traffic lights, light timing/stats information, slope and curvature of the road, lane markings, and roadside objects such as signposts, including what the signage denotes. By way of example, the HD mapping data enables highly automated vehicles to precisely localize themselves on the road.

In one embodiment, geographic features (e.g., two-dimensional, or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent a footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the map database 106.
“Node”—A point that terminates a link.
“Line segment”—A straight line connecting two points.
“Link” (or “edge”)—A contiguous, non-branching string of one or more line segments terminating in a node at each end.
“Shape point”—A point along a link between two nodes (e.g., used to alter the shape of the link without defining new nodes).
“Oriented link”—A link that has a starting node (referred to as the “reference node”) and an ending node (referred to as the “non-reference node”).
“Simple polygon”—An interior area of an outer boundary formed by a string of oriented links that begins and ends in one node. In one embodiment, a simple polygon does not cross itself.
“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the map database 106 follows certain conventions. For example, links do not cross themselves and do not cross each other except at a node. Also, there are no duplicated shape points, nodes, or links. Two links that connect each other have a common node. In the map database 106, overlapping geographic features are represented by overlapping polygons. When polygons overlap, the boundary of one polygon crosses the boundary of the other polygon. In the map database 106, the location at which the boundary of one polygon intersects the boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the map database 106 includes node data records 1004, road segment or link data records 1006, geometry information records 1008, altitude and terrain information records 1010, HD mapping data records 1012, and indexes 1014, for example. In some examples, the user data may be stored as the node data records 1004, the road segment or the link data records 1006, the geometry information records 1008, the altitude and terrain information records 1010, the HD mapping data records 1012, and the indexes 1014. More, fewer, or different data records can be provided. In some embodiments, the altitude and terrain information records 1010 may be stored in the map database 106. In one embodiment, additional data records (not shown) can include cartographic (“carto”) data records, routing data, and maneuver data. In one embodiment, the indexes 1014 may improve the speed of data retrieval operations in the map database 106. In one embodiment, the indexes 1014 may be used to quickly locate data without having to search every row in the map database 106 every time it is accessed. For example, in one embodiment, the indexes 1014 can be a spatial index of the polygon points associated with stored feature polygons. In one or more embodiments, data of a data record may be attributes of another data record.

In exemplary embodiments, the road segment data records 1006 are links or segments representing roads, streets, paths, or bicycle lanes, as can be used in the calculated route or recorded route information for the determination of speed profile data. The node data records 1004 are endpoints (for example, representing intersections or an end of a road) corresponding to the respective links or segments of the road segment data records 1006. The road segment data records 1006 and the node data records 1004 represent a road network, such as used by vehicles, cars, and/or other entities. Alternatively, the map database 106 can contain path segment and node data records or other data that represent pedestrian paths or areas in addition to or instead of the vehicle road record data, for example. In an embodiment, the system 100 may be configured to store the calculated first error associated with each of the first set of reference points. As discussed above, the obtained first set of features may be associated with at least one of: altitude information associated with the respective reference point, or terrain information associated with the respective reference point, or a combination thereof. Furthermore, in some embodiments, the system 100 may be configured to associate the first set of reference points and the corresponding first error with a road segment (or a lane in the road segment) as the road segment data records 1006.

The road/link segments and nodes can be associated with attributes, such as geographic coordinates, street names, address ranges, speed limits, turn restrictions at intersections, and other navigation-related attributes, as well as POIs, such as gasoline stations, hotels, restaurants, museums, stadiums, offices, automobile dealerships, auto repair shops, buildings, stores, parks, etc. The map database 106 can include data about the POIs and their respective locations in the geometry information records 1008. The map database 106 can also include data about road attributes (e.g., traffic lights, stop signs, yield signs, roundabouts, lane count, road width, lane width, etc.), places, such as cities, towns, or other communities, and other geographic features, such as bodies of water, mountain ranges, etc. Such place or map feature data can be part of the geometry information records 1008.

In one embodiment, the map database 106 can also include the altitude and terrain information records 1010 for altitude and terrain information associated with the links, and/or any other related data that is used or generated according to the embodiments described herein. By way of example, the altitude and terrain information records 1010 can be associated with one or more of the node records 1004, the road segment records 1006, and/or the geometry information records 1008 to associate the speed profile data records with specific places, POIs, geographic areas, and/or other map features. In this way, the linearized data records can also be associated with the characteristics or metadata of the corresponding records 1004, 1006, and/or 1008.

In one embodiment, as discussed above, the HD mapping data records 1012 model road surfaces and other map features to centimeter-level or better accuracy. The HD mapping data records 1012 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 1012 are divided into spatial partitions of varying sizes to provide HD mapping data to end-user devices with near real-time speed without overloading the available resources of the devices (e.g., computational, memory, bandwidth, etc. resources).

In one embodiment, the HD mapping data records 1012 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 1012.

In one embodiment, the HD mapping data records 1012 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the map database 106 can be maintained by the content provider 118 in association with the mapping platform 102 (e.g., a map developer or service provider). The map developer can collect geographic data to generate and enhance the map database 106. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The map database 106 can be a master geographic database stored in a format that facilitates updating, maintenance, and development. For example, the master geographic database or data in the master geographic database can be in an Oracle spatial format or other format (e.g., capable of accommodating multiple/different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end-user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by vehicle and/or the UE. The navigation-related functions can correspond to vehicle navigation, pedestrian navigation, or other types of navigation. The compilation to produce the end-user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for processing the location sensor data 108A may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

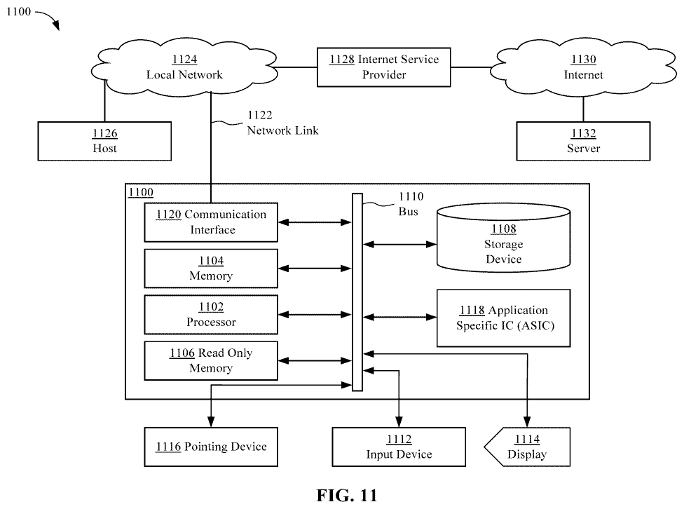

FIG. 11 is a diagram of hardware that can be used to implement an embodiment. Computer system 1100 is programmed (e.g., via computer program code or instructions) for the prediction of errors in location sensor data as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic, and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

The bus 1110 includes one or more parallel conductors of information so that information is transferred quickly among devices coupled to the bus 1110. One or more processors 1102 for processing information are coupled with the bus 1110.

A processor 1102 performs a set of operations on information as specified by computer program code related to the processing of the geometry information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations includes bringing information in from the bus 1110 and placing information on the bus 1110. The set of operations also typically includes comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitutes processor instructions, also called computer system instructions or, simply, computer instructions. Processors may be implemented as mechanical, electrical, magnetic, optical, chemical, or quantum components, among others, alone or in combination.

The computer system 1100 also includes a memory 1104 coupled to bus 1110. The memory 1104, such as a random access memory (RAM) or other dynamic storage device, stores information including processor instructions for processing the geometry information. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during the execution of processor instructions. The computer system 1100 also includes a read-only memory (ROM) 1106 or other static storage device coupled to the bus 1110 for storing static information, including instructions, which is not changed by the computer system 1100. Some memory is composed of volatile storage that loses the information stored thereon when power is lost. Also coupled to the bus 1110 is a non-volatile (persistent) storage device 1108, such as a magnetic disk, optical disk, or flash card, for storing information, including instructions, which persists even when the computer system 1100 is turned off or otherwise loses power.

Information, including instructions for processing the geometry information, is provided to the bus 1110 for use by the processor from an external input device 1112, such as a keyboard containing alphanumeric keys operated by a human user, or a sensor. A sensor detects conditions in its vicinity and transforms those detections into physical expressions compatible with the measurable phenomenon used to represent information in computer system 1100. Other external devices coupled to bus 1110, used primarily for interacting with humans, include a display device 1114, such as a cathode ray tube (CRT), a liquid crystal display (LCD), or a plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more external input devices 1112, display device 1114, and pointing device 1116 is omitted.

In the illustrated embodiment, special-purpose hardware, such as an application-specific integrated circuit (ASIC) 1118, is coupled to the bus 1110. The special purpose hardware is configured to perform operations not performed by processor 1102 quickly enough for special purposes. Examples of application-specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 1100 also includes one or more instances of a communications interface 1120 coupled to bus 1110. The communication interface 1120 provides a one-way or two-way communication coupling to a variety of external devices that operate with their processors, such as printers, scanners, and external disks. In general, the coupling is with a network link 1122 that is connected to a local network 1124 to which a variety of external devices with their own processors are connected. For example, the communication interface 1120 may be a parallel port or a serial port, or a universal serial bus (USB) port on a personal computer. In some embodiments, communications interface 1120 is an integrated services digital network (ISDN) card or a digital subscriber line (DSL) card or a telephone modem that provides an information communication connection to a corresponding type of telephone line. In some embodiments, the communication interface 1120 is a cable modem that converts signals on the bus 1110 into signals for a communication connection over a coaxial cable or into optical signals for a communication connection over a fiber optic cable. As another example, communications interface 1120 may be a local area network (LAN) card to provide a data communication connection to a compatible LAN, such as Ethernet. Wireless links may also be implemented. For wireless links, the communications interface 1120 sends or receives or both sends and receives electrical, acoustic, or electromagnetic signals, including infrared and optical signals, which carry information streams, such as digital data. For example, in wireless handheld devices, such as mobile telephones like cell phones, the communications interface 1120 includes a radio band electromagnetic transmitter and receiver called a radio transceiver. In certain embodiments, the communications interface 1120 enables connection to the communication network 120 for processing the geometry information.

The term computer-readable medium is used herein to refer to any medium that participates in providing information to processor 1102, including instructions for execution. Such a medium may take many forms, including, but not limited to, non-volatile media, volatile media, and transmission media. Non-volatile media include, for example, optical or magnetic disks, such as storage device 1108. Volatile media include, for example, dynamic memory 1104. Transmission media include, for example, coaxial cables, copper wire, fiber optic cables, and carrier waves that travel through space without wires or cables, such as acoustic waves and electromagnetic waves, including radio, optical, and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1122 typically provides information communication using transmission media through one or more networks to other devices that use or process the information. For example, the network link 1122 may provide a connection through local network 1124 to a host computer 1126 or to equipment 1128 operated by an Internet Service Provider (ISP). ISP equipment 1128 in turn provides data communication services through the public, worldwide packet-switching communication network of networks now commonly referred to as the Internet 1130.

A computer called a server host 1132 connected to the Internet hosts a process that provides a service in response to information received over the Internet. For example, server host 1132 hosts a process that provides information representing video data for presentation at display 1114. It is contemplated that the components of the system can be deployed in various configurations within other computer systems, e.g., host 1126 and server 1132.

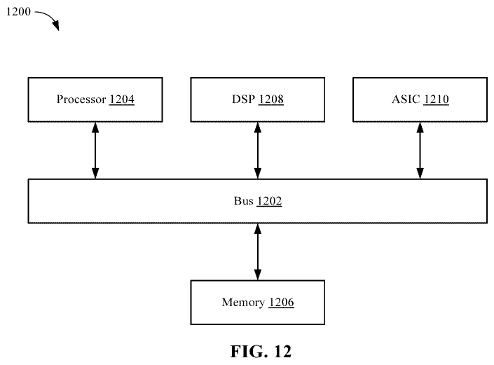

FIG. 12 is a diagram of a chipset 1200 that can be used to implement an embodiment. The chipset 1200 is programmed to process the location sensor data 108A as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chipset 1200 includes a communication mechanism such as a bus 1202 for passing information among the components of the chipset 1200. A processor 1204 has connectivity to the bus 1202 to execute instructions and process information stored in, for example, a memory 1206. The processor 1204 may include one or more processing cores with each core configured to perform independently. A multi-core processor enables multiprocessing within a single physical package. Examples of a multi-core processor include two, four, eight, or greater numbers of processing cores. Alternatively, or in addition, the processor 1204 may include one or more microprocessors configured in tandem via the bus 1202 to enable independent execution of instructions, pipelining, and multithreading. The processor 1204 may also be accompanied by one or more specialized components to perform certain processing functions and tasks such as one or more digital signal processors (DSP) 1208, or one or more application-specific integrated circuits (ASIC) 1210. A DSP 1208 typically is configured to process real-world signals (e.g., sound) in real time independently of the processor 1204. Similarly, an ASIC 1210 can be configured to perform specialized functions not easily performed by a general-purpose processor. Other specialized components to aid in performing the inventive functions described herein include one or more field programmable gate arrays (FPGA) (not shown), one or more controllers (not shown), or one or more other special-purpose computer chips.

The processor 1204 and accompanying components have connectivity to the memory 1206 via the bus 1202. The memory 1206 includes both dynamic memory (e.g., RAM, magnetic disk, writable optical disk, etc.) and static memory (e.g., ROM, CD-ROM, etc.) for storing executable instructions that when executed perform the inventive steps described herein to process the location sensor data 108A. The memory 1206 also stores the data associated with or generated by the execution of the inventive steps.

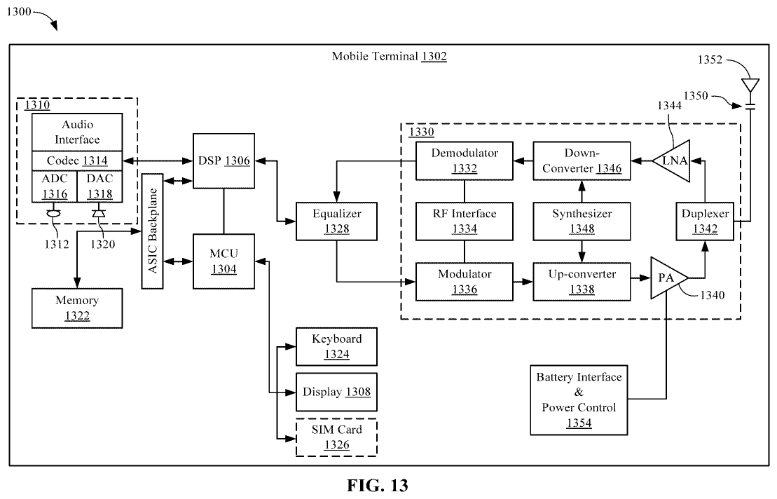

FIG. 13 is a diagram of a mobile terminal 1302 (e.g., handset, vehicle, or part thereof) that can be used to implement an embodiment. Generally, a radio receiver is often defined in terms of front-end and back-end characteristics. The front end of the receiver encompasses all of the Radio Frequency (RF) circuitry whereas the back end encompasses all of the base-band processing circuitry. Pertinent internal components of the telephone include a Main Control Unit (MCU) 1304, a Digital Signal Processor (DSP) 1306, and a receiver/transmitter unit including a microphone gain control unit and a speaker gain control unit. A main display unit 1308 provides a display to the user in support of various applications and mobile station functions that offer automatic contact matching. An audio function circuitry 1310 includes a microphone 1312 and microphone amplifier that amplifies the speech signal output from the microphone 1312. The amplified speech signal output from the microphone 1312 is fed to a coder/decoder (CODEC) 1314.

A radio section 1330 amplifies power and converts frequency in order to communicate with a base station, which is included in a mobile communication system, via antenna 1352. The power amplifier (PA) 1340 and the transmitter/modulation circuitry are operationally responsive to the MCU 1304, with an output from the PA 1340 coupled to the duplexer 1342 or circulator or antenna switch, as known in the art. The PA 1340 also couples to a battery interface and power control unit 054.

In use, a user of mobile station 1302 speaks into the microphone 1312, and his or her voice along with any detected background noise is converted into an analog voltage. The analog voltage is then converted into a digital signal through the Analog to Digital Converter (ADC) 1316. The control unit 1304 routes the digital signal into the DSP 1306 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (Wi-Fi), satellite, and the like.

The encoded signals are then routed to an equalizer 1328 for compensation of any frequency-dependent impairments that occur during transmission through the air such as phase and amplitude distortion. After equalizing the bit stream, the modulator 1336 combines the signal with an RF signal generated in the RF interface 1334. The modulator 1336 generates a sine wave by way of frequency or phase modulation. In order to prepare the signal for transmission, an up-converter 1338 combines the sine wave output from the modulator 1336 with another sine wave generated by a synthesizer 1348 to achieve the desired frequency of transmission. The signal is then sent through a PA 1340 to increase the signal to an appropriate power level. In practical systems, the PA 1340 acts as a variable gain amplifier whose gain is controlled by the DSP 1306 from information received from a network base station. The signal is then filtered within the duplexer 1342 and optionally sent to an antenna coupler 1350 to match impedances to provide maximum power transfer. Finally, the signal is transmitted via antenna 1352 to a local base station. An automatic gain control (AGC) can be supplied to control the gain of the final stages of the receiver. The signals may be forwarded from there to a remote telephone which may be another cellular telephone, other mobile phone, or a landline connected to a Public Switched Telephone Network (PSTN), or other telephony networks.

Voice signals transmitted to the mobile station 1302 are received via antenna 1352 and immediately amplified by a low noise amplifier (LNA) 1344. A down-converter 1346 lowers the carrier frequency while the demodulator 1332 strips away the RF leaving only a digital bit stream. The signal then goes through the equalizer 1328 and is processed by the DSP 1306. A Digital to Analog Converter (DAC) 1318 converts the signal and the resulting output is transmitted to the user through the speaker 1320, all under the control of a Main Control Unit (MCU) 1304 which can be implemented as a Central Processing Unit (CPU) (not shown).

The MCU 1304 receives various signals including input signals from the keyboard 1324. The keyboard 1324 and/or the MCU 1304 in combination with other user input components (e.g., the microphone 1312) comprise a user interface circuitry for managing user input. The MCU 1304 runs a user interface software to facilitate user control of at least some functions of the mobile station 1302 for processing the user data 138A. The MCU 1304 also delivers a display command and a switch command to the display 1308 and the speech output switch controller, respectively. Further, the MCU 1304 exchanges information with the DSP 1306 and can access an optionally incorporated SIM card 1326 and a memory 1322. In addition, the MCU 1304 executes various control functions required of the station. The DSP 1306 may, depending upon the implementation, perform any of a variety of conventional digital processing functions on the voice signals. Additionally, DSP 1306 determines the background noise level of the local environment from the signals detected by microphone 1312 and sets the gain of microphone 1312 to a level selected to compensate for the natural tendency of the user of the mobile station 1302.

The CODEC 1314 includes the ADC 1316 and DAC 1318. The memory 1322 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1322 may be, but is not limited to, a single memory, CD, DVD, ROM, RAM, EEPROM, optical storage, or any other non-volatile or non-transitory storage medium capable of storing digital data.

An optionally incorporated SIM card 1326 carries, for instance, important information, such as the cellular phone number, the carrier supplying service, subscription details, and security information. The SIM card 1326 serves primarily to identify the mobile station 1302 on a radio network. The card 1326 also contains a memory for storing a personal telephone number registry, text messages, and user-specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
retrieving, from a map database, lane geometry information associated with a first lane within a first road link in a geographic region;
obtaining first location sensor data for a first set of reference points, wherein the first location sensor data is obtained from at least one vehicle traveling on a road associated with the first lane;
associating each reference point with a respective portion of the lane geometry information;
calculating a first error associated with the obtained first location sensor data based on the respective portion of lane geometry information;
obtaining a first set of features associated with each of the first set of reference points, wherein the obtained first set of features are associated with at least one of: altitude information associated with the respective reference point, or terrain information associated with the respective reference point, or a combination thereof; and
training a machine learning (ML) model using the calculated first error and the obtained first set of features.

2. The method of claim 1, further comprising:
retrieving, from the map database, first map data associated with the first road link based on the obtained first location sensor data; and
calculating the first error associated with the obtained first location sensor data further based on the retrieved first map data.

3. The method of claim 1, wherein the first set of features are further associated with at least one of: lane information associated with the first road link, functional class information associated with the first road link, traffic information associated with the first road link, dimension information associated with the first road link, road link environment information associated with the first road link, and wherein the road link environment information comprises of information associated with buildings along the first road link and first road link infrastructure.

4. The method of claim 1, further comprising:
calculating a mean altitude value for the first lane based on the altitude information associated with each reference point of the first set of reference points;
calculating a standard deviation value associated with a steepness of a terrain of the first lane based on the terrain information associated with each reference point of the first set of reference points; and
training the ML model using the calculated mean altitude value and the calculated standard deviation value.

5. The method of claim 1, further comprising:
segmenting the first lane of the first road link into a first subset of lane segments based on at least one distance criterion; and
selecting at least one reference point of the first set of reference points from each lane segment of the first subset of lane segments.

6. The method of claim 1, further comprising:
querying the map database for at least one of a bridge, a tunnel, or a parking structure, wherein the at least one of the bridge, the tunnel, or the parking structure is within a predetermined distance of a first lane segment within the first lane; and
determining a second set of reference points for the first lane segment corresponding to at least one of the bridge, the tunnel, or the parking structure.

7. The method of claim 6, further comprising:
obtaining a second set of features associated with each reference point of the determined second set of reference points; and
training the ML model further using the obtained second set of features associated with each reference point of the determined second set of reference points.

8. The method of claim 1, further comprising:
updating the map database with a value corresponding to the calculated first error associated with the first lane.

9. The method of claim 1, further comprising:
obtaining a third set of features associated with each of a third set of reference points, wherein the obtained third set of features are associated with a second lane of the first road link;
providing, as an input, the obtained third set of features to the ML model; and
predicting a second error associated with the second lane of the first road link based on an output of the ML model.

10. A system comprising:
at least one processor; and
at least one memory including computer program code for one or more programs, and a machine learning (ML) model trained on first training dataset associated with at least a first lane within a first road link;
the at least one memory and the computer program code configured to, with the at least one processor, cause the system to perform at least the following:
retrieve, from a map database, lane geometry information associated with a second lane within a second road link in a geographic region;
obtain second location sensor data for a second set of reference points, wherein the second location sensor data is obtained from at least one vehicle traveling on a road associated with the second lane;
obtain a second set of features associated with each of the second set of reference points, wherein the obtained second set of features are associated with at least one of: altitude information associated with the respective reference point, or terrain information associated with the respective reference point, or a combination thereof;
provide, as an input, the obtained second set of features to the ML model; and
predict a second error associated with at least one of the second location sensor data, the second lane, or the obtained second set of features associated with the second lane based on an output of the ML model.

11. The system of claim 10, wherein the second set of features are further associated with at least one of: lane information associated with the second road link, functional class information associated with the second road link, traffic information associated with the second road link, dimension information associated with the second road link, road link environment information associated with the second road link, and wherein the road link environment information comprises of information associated with buildings along the second road link and second road link infrastructure.

12. The system of claim 10, wherein the system is further caused to:
calculate a mean altitude value for the second lane based on the altitude information associated with each reference point of the second set of reference points;
calculate a standard deviation value associated with a steepness of a terrain of the second lane based on the terrain information associated with each reference point of the second set of reference points;
provide, as the input, the calculated mean altitude value and the calculated standard deviation value to the ML model; and
calculate the second error associated with at least one of the second lane or the obtained second set of features associated with the second lane based on an output of the ML model.

13. The system of claim 10, wherein the system is further caused to:
segment the second lane of the second road link into a second subset of lane segments based on at least one distance criterion; and
select at least one reference point of the second set of reference points from each lane of the second subset of lane segments.

14. The system of claim 10, wherein the system is further caused to:
query the map database for at least one of a bridge, a tunnel, or a parking structure, wherein at least one of the bridge, the tunnel, or the parking structure is within a predetermined distance of a first lane segment within the second lane; and
determine a second set of reference points for the first lane segment corresponding to at least one of the bridge, the tunnel, or the parking structure.

15. The system of claim 14, wherein the system is further caused to:
obtain a third set of features associated with each reference point of the determined second set of reference points;
provide, as the input, the obtained third set of features to the ML model; and
predict the second error associated with at least one of the second location sensor data, the second lane, or the obtained second set of features associated with the second lane based on the output of the ML model.

16. The system of claim 10, wherein the system is further caused to update a map database with a value corresponding to the predicted second error associated with the second lane.

17. The system of claim 10, wherein the system is further caused to:
compare the predicted second error associated with the second lane with a pre-determined error threshold; and
transmit, based on the comparison, a control command to at least one vehicle traveling on a road associated with the second lane, to control a driving mode of the at least one vehicle, wherein controlling the driving mode of the at least one vehicle corresponds to switching from a first driving mode to a second driving mode.

18. A non-transitory computer-readable medium having stored thereon, computer-executable instructions that when executed by a processor of a system, causes the processor to execute operations, the operations comprising:
retrieving, from a map database, lane geometry information associated with a second lane within a second road link in a geographic region;
obtaining second location sensor data for a second set of reference points, wherein the second location sensor data is obtained from at least one vehicle traveling on a road associated with the second lane;
obtaining a second set of features associated with each of the second set of reference points, wherein the obtained second set of features are associated with at least one of: altitude information associated with the respective reference point, or terrain information associated with the respective reference point, or a combination thereof;
providing, as an input, the obtained second set of features to a ML model trained on first training dataset associated with at least a first lane within a first road link; and
predicting a second error associated with at least one of the second location sensor data, the second lane, or the obtained second set of features associated with the second lane based on an output of the ML model.

19. The non-transitory computer-readable medium of claim 18, wherein the second set of features is further associated with at least one of: lane information associated with the second road link, functional class information associated with the second road link, traffic information associated with the second road link, dimension information associated with the second road link, road link environment information associated with the second road link, and wherein the road link environment information comprises of information associated with buildings along the second road link and second road link infrastructure.

20. The non-transitory computer-readable medium of claim 18, further comprising:
calculating a mean altitude value for the second lane based on the altitude information associated with each reference point of the second set of reference points;
calculating a standard deviation value associated with a steepness of a terrain of the second lane based on the terrain information associated with each reference point of the second set of reference points;
providing, as the input, the calculated mean altitude value and the calculated standard deviation value to the ML model; and
calculating the second error associated with at least one of the second lane or the obtained second set of features associated with the second lane based on an output of the ML model.
